(19) United States
(12) Patent Application Publication
(10) Pub. No.: US 2022/0207796 A1
(43) Pub. Date: Jun. 30, 2022

(54) Processing Geospatial Data

(71) Applicant: Modumos Limited, Poole (GB)

(72) Inventors: Peter Thomas Bowdler, Poole (GB); Edwin Morey, Lymington (GB)

(21) Appl. No.: 17/557,852

(22) Filed: Dec. 21, 2021

(30) Foreign Application Priority Data
Dec. 22, 2020 (GB) 2020480.6

(51) Int. Cl. G06T 11/20; G06T 7/11; G06T 7/70

(52) U.S. Cl. CPC G06T 11/203; G06T 7/70; G06T 7/11

(57) ABSTRACT

A method of automatically processing geospatial data is implemented by apparatus including a processor, storage and memory. Base geospatial data is obtained relating to plots of land and buildings, and first geospatial data is identified describing a first real-world plot of land and second geospatial data is identified describing a first real-world building standing on it, the building having an unknown real-world orientation. Using the second geospatial data, a first polygon is created that encompasses the building. Using the first geospatial data, a portion polygon is identified that is not in the first polygon, which defines a portion of the plot of land. Its orientation with respect to the real-world orientation of the building is identified. The portion polygon and data relating to the portion of the plot of land are stored for display.

### CROSS REFERENCE TO RELATED APPLICATIONS

This application claims priority from UK Patent Application No. 20 20 480.6, filed 22 Dec. 2020.

### BACKGROUND OF THE INVENTION

The present invention relates to a system and method for automatically processing geospatial data.

Geospatial data describing and defining plots of land across the world is created and stored by various agencies, some private and some governmental. Similarly, mapping data describing features on a landscape such as roads and buildings is defined by geospatial data and can be used to generate maps for display online and in print.

Frequently, plots of land on which buildings stand are large enough to be segmented so that additional buildings can be constructed. However, there is currently no way of automatically identifying such plots of land.

### BRIEF SUMMARY OF THE INVENTION

According to a first aspect of the present invention, there is provided a method of processing geospatial data according to claim 1. According to a second aspect of the present invention, there is provided apparatus for processing geospatial data according to claim 14. According to a third aspect of the present invention, there is provided a transitory computer readable medium comprising instructions according to claim 20.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 illustrates an environment in which the invention may be implemented;

FIG. 2 is a schematic illustration of communications between devices shown in FIG. 1;

FIG. 3 shows steps carried out by a processor of the data generation system shown in FIG. 1;

FIG. 4a is a schematic illustration of a base database shown in FIG. 2;

FIG. 4b is a schematic illustration of a working database shown in FIG. 2;

FIG. 5 details steps carried out during FIG. 3 to generate potential plot data;

FIG. 6 details steps carried out during FIG. 5 process a candidate plot;

FIGS. 7a and 7b illustrate steps carried out during FIG. 6;

FIG. 8 details steps carried out during FIG. 6 to define potential plot;

FIG. 9 illustrates steps carried out during FIG. 8;

FIG. 10 details steps carried out during FIG. 6 to orientate a candidate plot;

FIGS. 11a and 11b illustrate steps carried out during FIG. 10;

FIG. 12 details steps carried out during FIG. 10 to identity left and right side plots;

FIG. 13 illustrates steps carried out during FIG. 12;

FIG. 14 details steps carried out during FIG. 6 to further process a potential plot;

FIG. 15 details steps carried out during FIG. 14 to process a rear plot;

FIG. 16 illustrates steps carried out during FIG. 15;

FIG. 17 details steps carried out during FIG. 15 to identify side access details;

FIG. 18 illustrates steps carried out during FIG. 17;

FIG. 19 details steps carried out during FIG. 15 to identify rear access details;

FIGS. 20a, 20b, 20c and 20d illustrate steps carried out during FIG. 19;

FIG. 21a details steps carried out during FIG. 14 to process a side plot;

FIG. 21b details steps carried out during FIG. 21a to identify the most suitable part of a side plot;

FIGS. 22a and 22b illustrate steps carried out during FIG. 21b;

FIG. 23 details steps carried out during FIG. 3 to generate assembled plots;

FIGS. 24a and 24b illustrate steps carried out during FIG. 23;

FIG. 25 is a schematic illustration of a live database and a user database shown in FIG. 2;

FIG. 26 details steps carried out during FIG. 3 to update the live database shown in FIG. 25;

FIG. 27 is a schematic illustration of component processes of a server process shown in FIG. 2;

FIG. 28 details a user notification process shown in FIG. 27

FIG. 29 details steps carried out during FIG. 21 to check if a side plot is usable;

FIG. 30 details steps carried out during FIG. 29 to check if a plot is on a corner;

FIG. 31 illustrates steps carried out during FIG. 30;

FIG. 32 details steps carried out during FIG. 29 to check if a plot is on a bend;

FIGS. 33a to 33c illustrates steps carried out during FIG. 32;

FIG. 34 also illustrates steps carried out during FIG. 32;

FIG. 35 details steps carried out during FIG. 21 to identify access details;

FIG. 36 illustrates steps carried out during FIG. 35;

FIG. 37 details steps carried out during FIG. 14 to perform optional checks on a processed plot;

FIG. 38 details steps carried out during FIG. 37 to check whether a fire suppression system is required; and

FIG. 39 illustrates steps carried out during FIG. 38.

### DETAILED DESCRIPTION OF EMBODIMENTS OF THE INVENTION

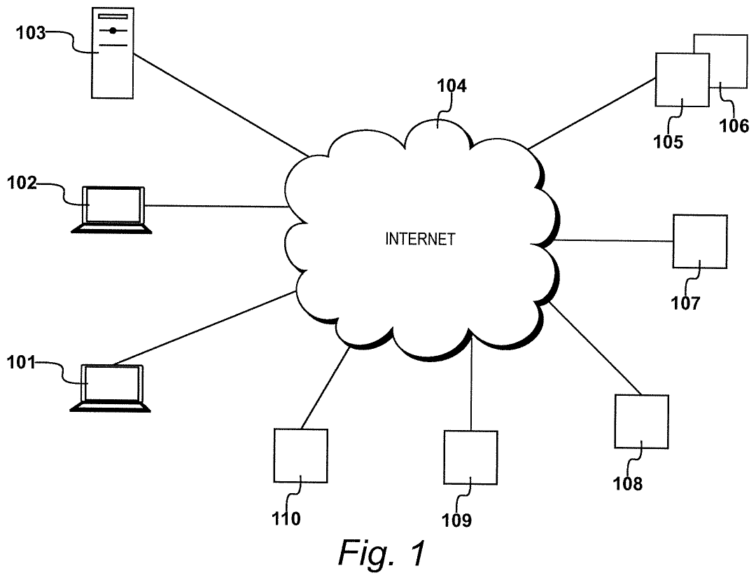

### FIG. 1

An environment in which the invention may be implemented is illustrated in FIG. 1. Terminals, such as computer 101, computer 102, and mobile device 103, are connected to the internet 104. The users of these terminals wish to search for usable plots of land on which buildings may be constructed.

Data relating to such plots of land is generated by data generation station 105, and stored on its local server 106 and on a remote server 107. Servers 106 and 107 may service the same users or different sets of users. Geospatial data used by data generation server 105 is imported from land data server 108 and feature data server 109. Additional information relating to the geospatial data may be imported from one or more additional data locations, represented here by server 110.

Intermediate connection devices such as gateways, cellular towers, internet service providers, etc are not shown in this Figure, and any suitable method of connecting to the internet could be used. Alternatively, connection could be made through other networks other than the internet, and one or more of the servers could be co-located.

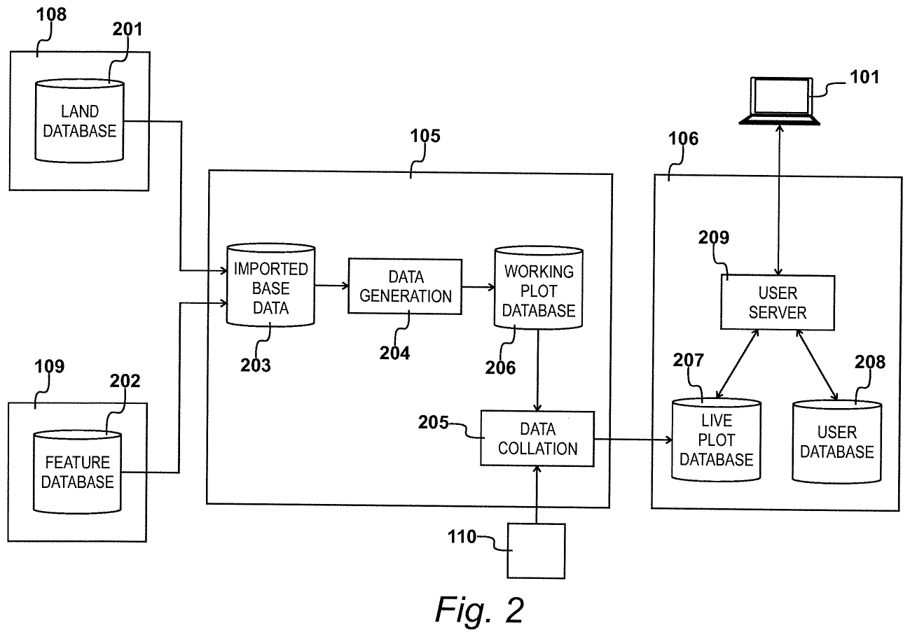

### FIG. 2

Communications between devices shown in FIG. 1 are shown schematically in FIG. 2. Land data server 108 stores a land database 201, which includes geospatial data describing plots of land. Feature data server 109 holds feature database 202, which includes geospatial data describing features of the landscape corresponding geographically to the geospatial data of land database 201. These databases are separate and must be collated by data generation station 105. However, in other embodiments these databases could be located on the same server, or the land and feature data could be stored in a single database.

Data generation station 105 imports data from land database 201 and feature database 202 and stores it as imported base data 203. Base data 203 is refreshed whenever one of databases 201 or 202 is updated.

A data generation process 204 runs on station 105, which generates geospatial data relating to usable plots of land and stores it in working plot database 206 on station 105.

A second process on station 105, data collation process 205, collates data from working database 204 and pushes it to live plot database 207 on server 106. Data collation process 205 may also fetch data from other locations 110 for storage on live database 207. The same live data is pushed to a database on remote server 107.

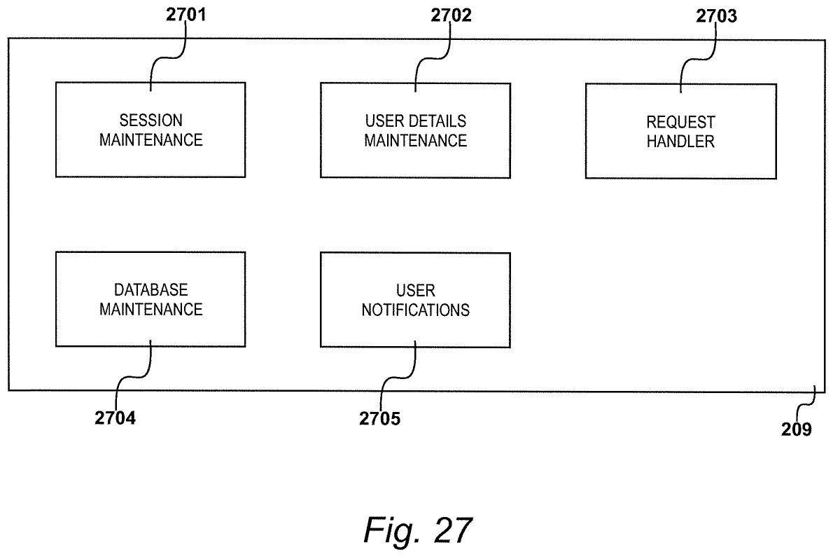

Server 106 stores, in addition to live database 207, a database of users 208. A server process 209 carries out various server functions, such as serving user requests, creating and updating records in user database 208, and so on, and will be described further with reference to FIG. 27. A user request may be for a search based on user-provided filters, for information on a particular plot, to save a plot in a user's list, and so on.

Thus, data generation station 105 imports base geospatial data from servers 108 and 109 and generates geospatial data for storage in live database 207. Typically, the processes on data generation station 105 run whenever one of databases 201 or 202 is updated. Meanwhile, server 106, and similarly server 107, provide the latest data to users in response to user requests.

Any other arrangement of the databases and processes could be used, and the design would depend upon the location of the base databases, the capabilities of the computing systems being used, the bandwidth of the local network, and so on.

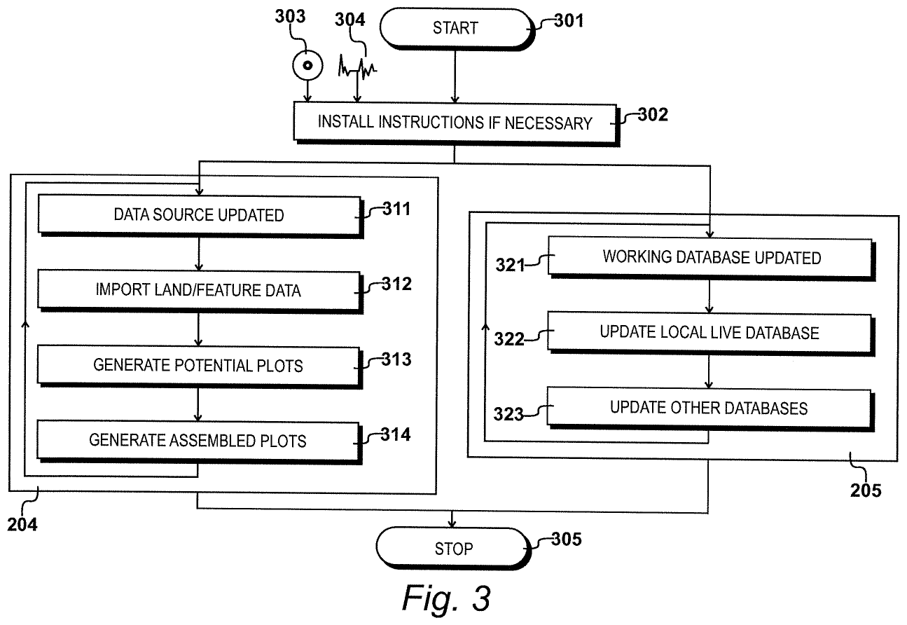

### FIG. 3

In this embodiment, data processing station is a computing system that includes a processor, memory and storage. Databases 203 and 206 may be stored on the storage, or may be on dedicated internal or external storage. They may also be on networked devices. Thus, data generation station 105 may be a single computing system or may be a network of devices. In addition, it may include more than one processor and more than one memory, or it may be a distributed system. Thus, reference herein to a processor may be to a single CPU or a plurality of processing devices, which may be contained in the same computing device or in a network of devices; similarly reference to a memory may be to one or more memory devices, and reference to storage may be to one or more storage devices.

FIG. 3 shows steps carried out by the processor of data generation system 105 to implement the invention. At step 301 the station is switched on and at step 302 instructions are installed if necessary. These may be installed from a physical medium such as CD-ROM 303, or from a networked location 304. These instructions are stored in storage, and loaded into memory to be run.

Data generation station 105 runs, in addition to many background processes and other processes not described herein, data generation process 204 and data collation process 205.

Data generation process 204 includes step 311 at which the process is notified that one or more of the data sources 201 and 202 has been updated, step 312 at which the data is imported, and steps 313 and 314 at which potential plots and assembled plots are generated respectively. The process then waits for notification of another update. As an alternative to an interrupt being received at step 311, each iteration of process 204 may be initiated by a user.

Data collation process 205 includes step 321 at which it is notified that working plot database 206 has been updated, step 322 at which it compares working database 206 with live database 207 to update old, edited or new data, and step 323 at which it pushes these updates to other live plot databases, such as on server 107. The process then waits to be notified of another update to working database 206. As an alternative to an interrupt being received at step 321, each iteration of process 205 may be initiated by a user. It may be appropriate for process 205 to run overnight to avoid data outages being experienced by users.

Processes 204 and 205 both run until such time as data generation station 105 is switched off at step 305.

The separation of the functions of data generation station 105 into two separate processes as illustrated here allows for efficient data generation. However, it could be split into many more processes, and the processes could be split over more than one computing system.

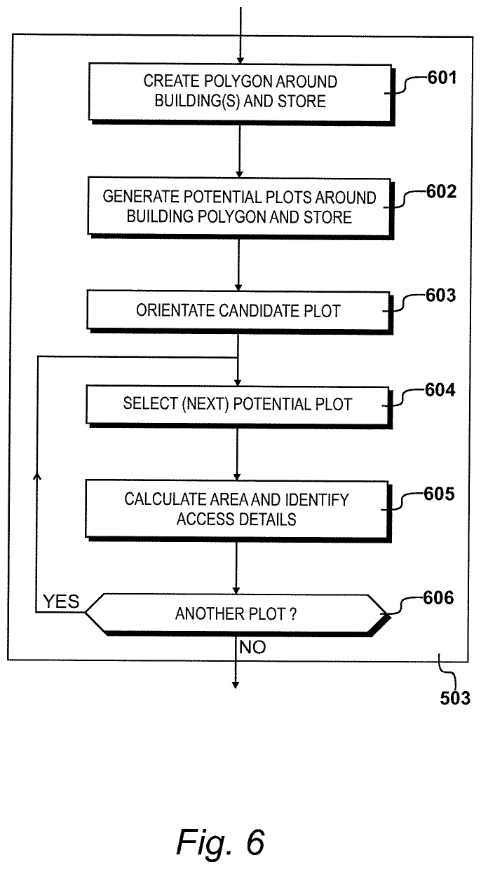

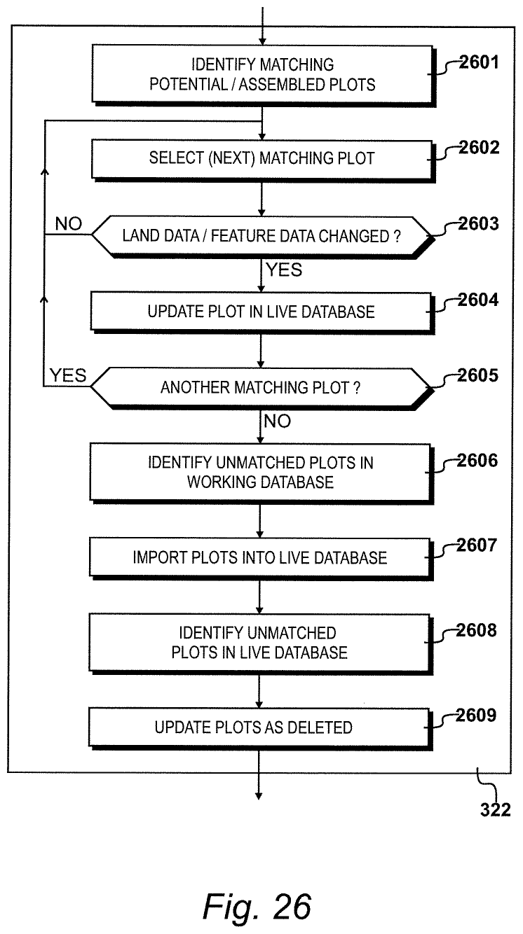

Data generation process 204 will be described with reference to FIGS. 5 to 24b, while data collation process 205 will be described with respect to FIG. 26.

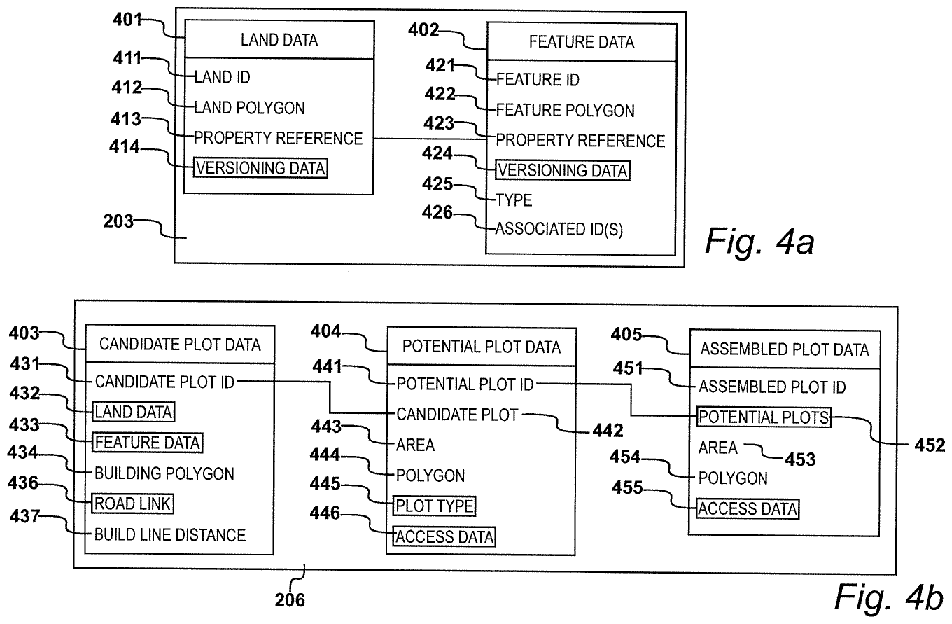

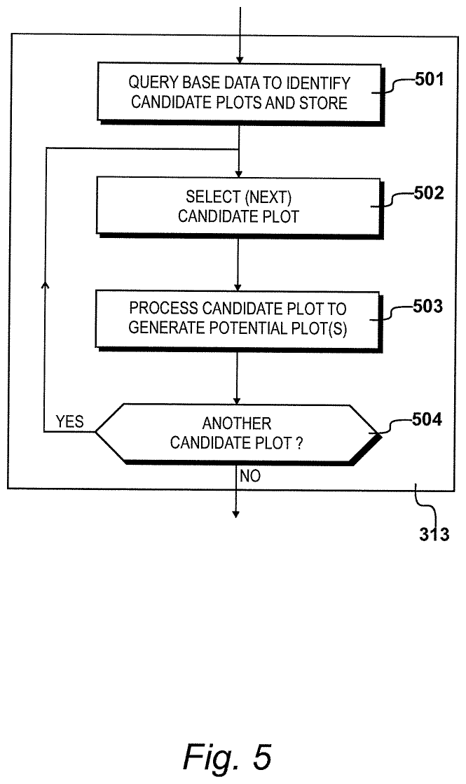

### FIG. 4a

Imported base data 203 is shown schematically in FIG. 4a. It includes land data 401 imported from land database 201 and feature data 402 imported from feature database 202. Two tables are shown in FIG. 4, but the data may be stored in any suitable format. Together, land data 401 and feature data 402 comprise base geospatial data. It should be noted that the term “geospatial data” means any data that has a geographic component to it. In this description, it is used to mean data that includes a area defined in some way and other data associated with that area.

Each record in land data 401 includes a land ID 411, a land polygon 412, a property reference 413 and versioning data 414. This data may be a copy of records in land database 201, or it may be the result of a query run on that database.

The land ID is a unique identifier that identifies a plot of land defined by land polygon 412, which is a set of coordinates. The coordinates are stored in order and may be joined by lines in a clockwise direction to create the polygon. Each coordinate identifies a point in the area under consideration; the absolute latitude or longitude may be used, or a local coordinate system. As an example, mapping data produced in the United Kingdom uses a two-dimensional coordinate system having an origin at 49° N, 2° W, to avoid the use of negative numbers. A polygon defined by coordinates is a typical way of storing geospatial data, but other storage methods may be used.

Each record in feature data 402 includes a feature ID 421, a feature polygon 422, a property reference 423, versioning data 424, the type of feature 425 and any associated feature IDs 426. Again, this data may be a direct import from feature database 202, or may be the result of a query.

Feature ID 421 is a unique identifier, and feature polygon 422 is geospatial data stored in the same way as land polygon 412. Again, other storage methods may be used. However, it is preferable that land polygon 412 and feature polygon 422 are stored in the same format, and therefore conversion may be necessary during the import step if databases 201 and 202 use different formats.

Property reference 423 can be linked by a database relationship to property reference 413. In the real world, if a building stands on a plot of land that is owned, then both the plot of land and the building are given the same property reference. This allows buildings and plots of land to be linked. This property reference may be present in databases 201 and 202. It is not, then the imported data will need to be processed to find feature polygons that are contained within land polygons and thereby generate property references.

Type field 425 indicates the type of feature. Mapping data includes all physical features, and therefore the feature could be a building, a road, a river, a high point, a telephone box or any other feature that appears on a map. Buildings may be further indicated as residential or commercial.

In addition, some features are associated with other features, and this is indicated in field 426. For example, a building is associated with a road, indicating its postal address.

The data structure 203 of imported base data is updated when necessary at step 312. In this embodiment the entire updated database, either database 201 or 202, is imported to replace the records in database 203 or 204 respectively. As an alternative, modified data could be selectively imported based on comparisons between the versioning data in the original database and the imported data. The base data 203 is processed at steps 313 and 314 to produce and update working plot database 206.

Thus there exists first geospatial data describing a plot of land, which in this example is land polygon 412 and its associated data in land data 401, and second geospatial data describing a building standing on it, which in this example is feature polygon 422 and its associated data in feature data 402. In other embodiments, the first and second geospatial data may be defined in other ways.

### FIG. 4b

Working plot database 206 is shown schematically in FIG. 4b. It is shown here for simplicity as three tables, but the data can be stored in any suitable way.

Each data record will be briefly described here, and further elaborated upon in the following Figures where it is described how the working data is generated. The data comprises three tables, table 403 of candidate plots, table 404 of potential plots, and table 405 of assembled plots.

Candidate plot data 403 is assembled by querying base data 203 to find suitable plots of land. Each record is given a candidate plot ID 431, and some or all of the land data and feature data is imported at locations 432 and 433. Locations 423 and 433, and others, are shown in a box to indicate that the data includes more than one field, which may be included in this table or may be in a linked table. When referring to the data in locations 432 and 433, the reference numerals from FIG. 4a will be used, but it should be understood that it is the corresponding data that has been imported into table 403 that is being referred to.

Geospatial data indicating a building polygon is at 434, road link data is at 435, and a build line distance is at 436.

Candidate plot data 403 is processed further to generate potential plot data 404. Each potential plot is a portion of an existing plot of land, which may or may not be suitable for constructing a building on. Thus, each record has a potential plot ID 441, a link 442 to a candidate plot, the area of the potential plot 443, geospatial data describing it at 444, and plot type data, including the type of plot (e.g. front, rear, side) and whether it is usable or not is at 445. Data relating to potential vehicular access to the plot is at 446.

Once the potential plots have been generated at step 313, an additional generation step takes place at 314 to create assembled plot data 405. Each assembled plot is defined by a number of adjacent potential plots which could be used as a single plot. Thus each record in the data 405 includes an assembled plot ID 451, a number of links 452 to potential plots 404, the area of the plot 453 and its defining polygon 544, and data regarding access 455.

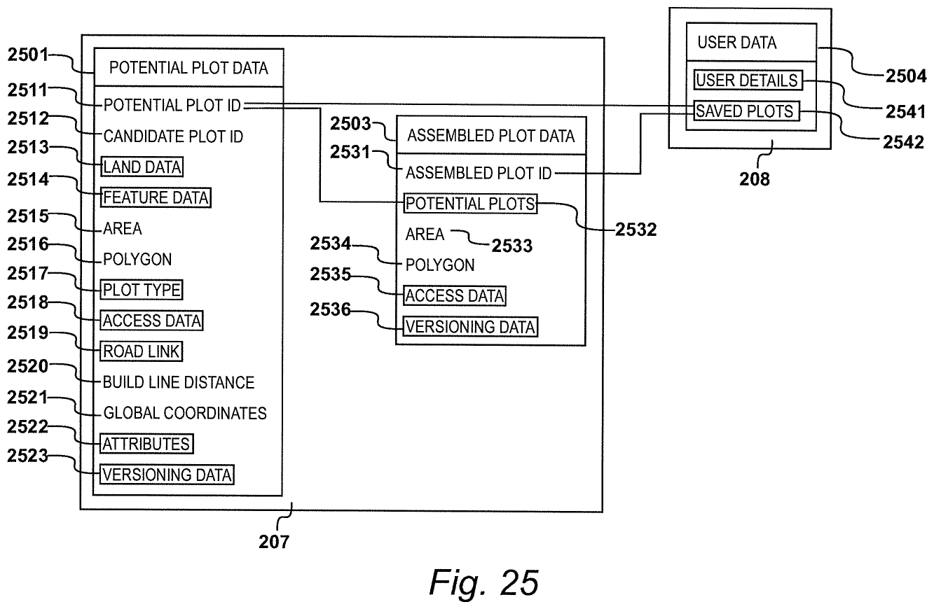

After all this data has been generated by process 204, process 205 collates the data that is changed when compared with live plot database 207, such as plots that are new, deleted or modified. This information is then pushed out to the live databases. Live database 207 will described with reference to the schematic in FIG. 25.

In another embodiment, data generation process could query the base data 203 to identify land data and feature data that is changed since the last update, and process only that data to create candidate plots and potential plots. This would be useful if the time taken to process the entirety of the base data were longer than the time between updates of the databases.

### FIG. 5

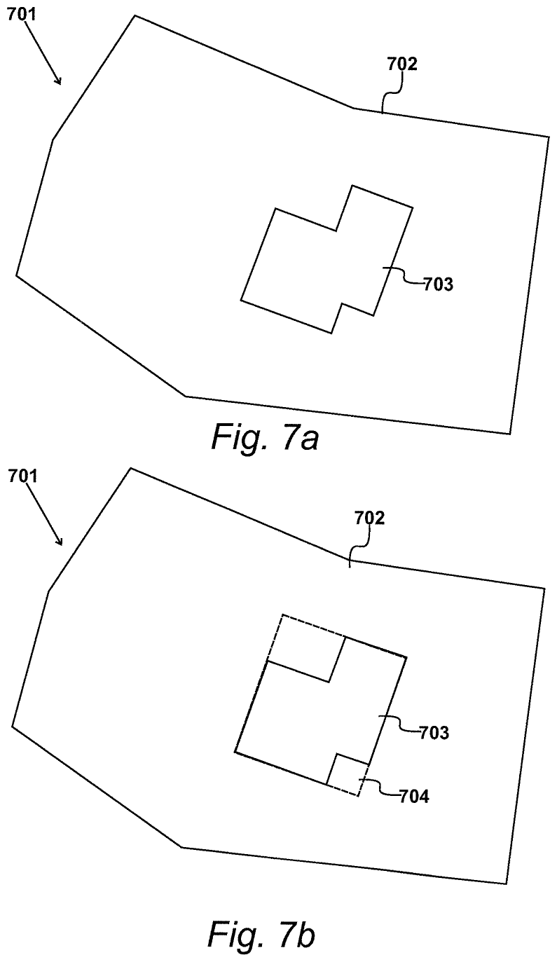

Step 313, at which potential plot data 404 is generated, is shown in FIG. 5, and will be further detailed in FIGS. 6 to 22. At step 501 the imported base data 203 is queried to identify candidate plots, which are stored in table 403. In this embodiment, candidate plots are those on which a residential building stands; in other embodiments commercial buildings and even plots without buildings could be included as well. In this embodiment, as previously described, all candidate plots are processed to generate potential plots, which are then compared with live database 207 to collate changes. If only updated data is required, then the versioning data would also be queried to identify candidate plots that have been changed since the last time process 204 was run.

Candidate plots discovered by querying databases 201 and 202 are stored in data table 401, as shown in FIG. 4a. Candidate plot ID 431 is generated by concatenating land ID 411 and feature ID 421. In other embodiments this ID could be hashed or otherwise normalised. Relevant land data is imported into location 432; this must include at least the land polygon 412 and versioning data 414. Relevant feature data is imported into location 433; this must include at least the feature polygon 422, the associated ID 426 of the building's road link, and versioning data 424.

Once the candidate plot data 403 has been created, at step 502 the first candidate plot record is selected. At step 503 the candidate plot is processed to generate potential plots which are stored in table 404, and at step 504 a question is asked as to whether there is another candidate plot record in the data. If this question is answered in the affirmative then control is returned step 502 and the next candidate plot is selected. Otherwise, step 313 is completed and all candidate plots have been processed to generate potential plots.

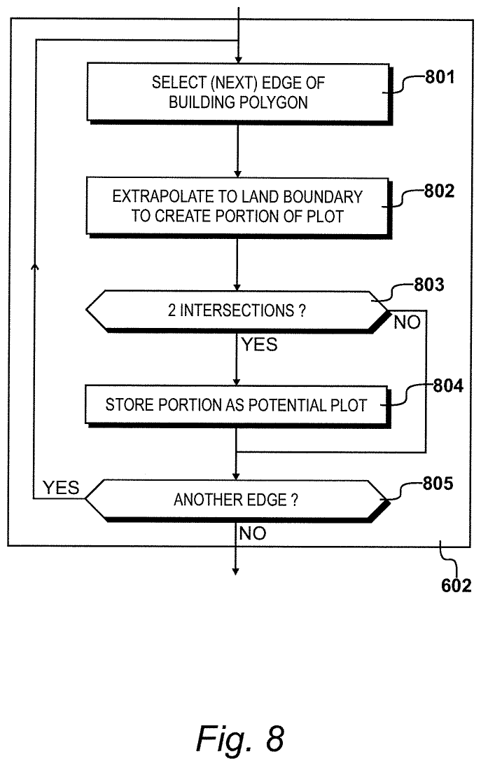

### FIGS. 6, 7a and 7b

FIG. 6 details step 503 at which a candidate plot is processed to generate one or more potential plots, illustrated in FIGS. 7a and 7b.

FIG. 7a illustrates the geospatial data described by a candidate plot. For ease of reference, it will be referred to herein as a candidate plot 701, but it should be recalled that candidate plot data 403 includes more data than just the geospatial data. Candidate plot 701 includes a land boundary 702, which is defined by the land polygon 412 stored in land data 432. As previously described, this polygon is defined by an ordered series of coordinates which can be displayed by drawing straight lines between them. Thus, each corner of land boundary 702 is a coordinate in the land polygon 412. The polygon is always closed.

Building 703 is similarly defined by feature polygon 422 stored in feature data 433. since both land boundary 702 and building 703 are stored as geospatial data within the database, geospatial database functions can be carried out upon them. However, in other embodiments, the following steps could be implemented using a programming language or in a mathematical computing environment.

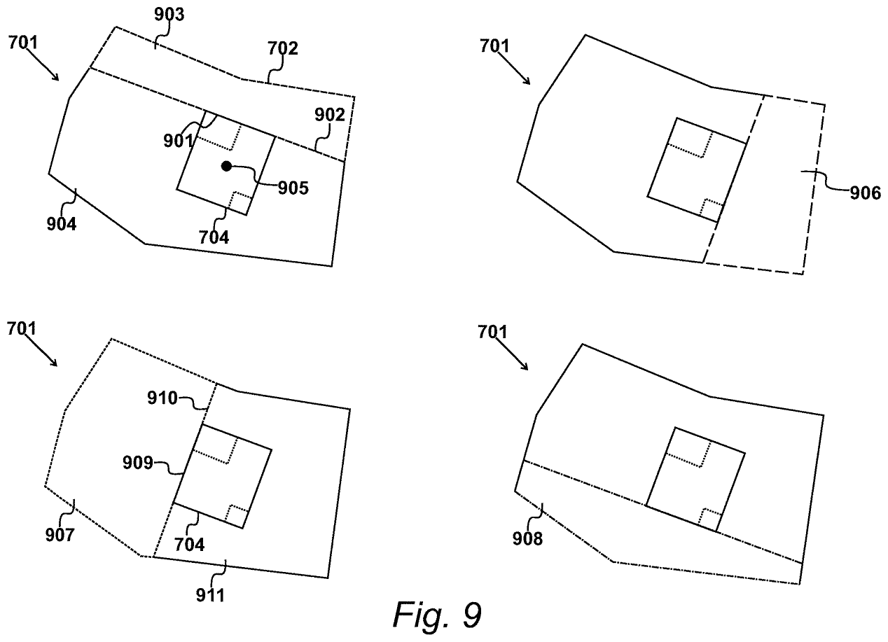

Returning to FIG. 6, at step 601 a polygon is created around building 703 and stored as building polygon 434. In this embodiment, the polygon is a best-fit rectangle, shown as a dashed line at 704 in FIG. 7b. Using a rectangle simplifies the operation of data generation. However, in other embodiments other polygon shapes could be used, or the precise outline of the building 703 used instead. Additionally, there may be more than one building on the plot, in which case the building polygon could encompass them both. At step 602 potential plots are generated around the building polygon 704 and stored in potential plot data 404, as will be detailed further with reference to FIG. 8.

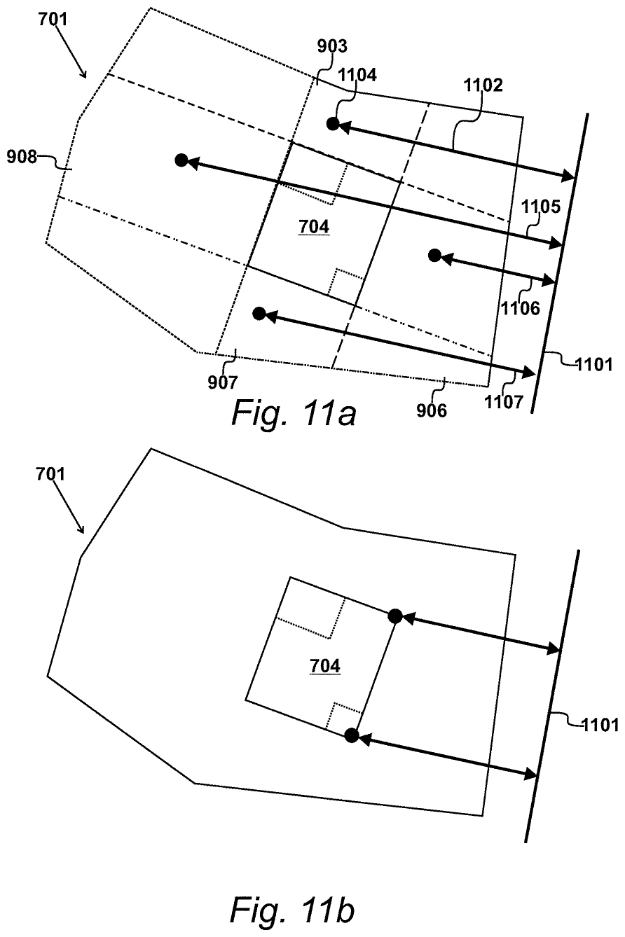

At step 603 the candidate plot is orientated, as will be detailed further with respect to FIG. 10. The candidate plot 701 contains no indication of where the front of building 703 is. However, the real-world building it represents does have a front. This must be identified since there are different considerations for front, rear, and side plots.

At step 604 the first potential plot generated at step 602 is selected, and at step 605 it is processed further to identify its usable area and whether it has access to a road. At step 606 a question is asked as to whether there is another potential plot in the candidate plot, and if this question is answered in the affirmative then control is returned to step 604 and the next plot is selected and processed. Otherwise, step 503 is completed.

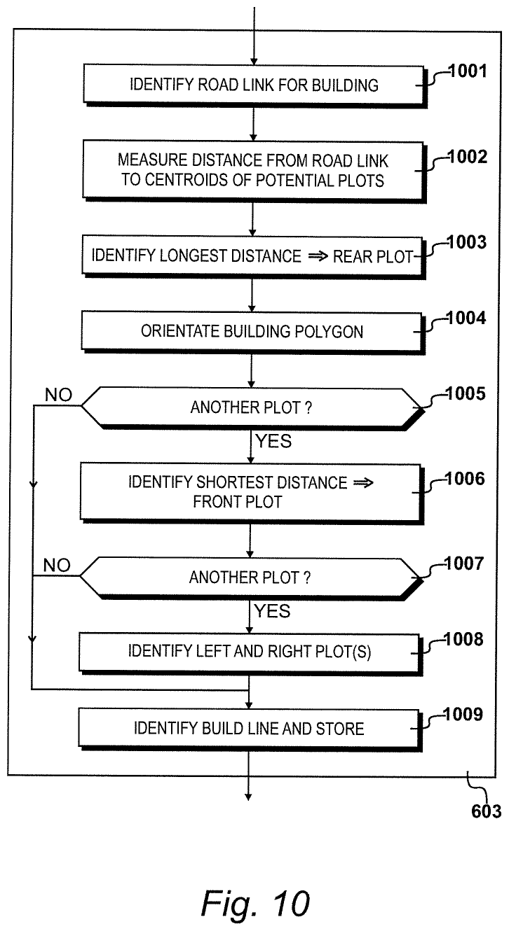

### FIGS. 8 and 9

Step 602, at which potential plots around building polygon 704 are defined, is detailed in FIG. 8 and illustrated in FIG. 9. At step 801, the first edge of building polygon 704 is selected. The order in which the edges are considered is not important. At step 802 the edge is extrapolated to land boundary 702 to create a portion of candidate plot 701. This is shown for all four edges of building polygon 704 in FIG. 9. Extrapolating edge 901 to the land boundary 702 produces line 902, which segments the plot.

At step 803 a question is asked as to whether there are precisely two intersections between the line and the land boundary, and if it is answered in the negative then this line results in an area that cannot be processed further.

If the line intersects the boundary in more than two places then this area of the plot has an irregularly shaped boundary. In other embodiments, such areas may be retained for processing.

If the question asked at step 803 is answered in the affirmative, then processing continues. The plot has been segmented into areas 903 and 904 by line 902, and the area which does not contain the centroid 905 of building polygon 704, i.e. portion 903, is added to the table 404 of potential plots at step 804. At this stage, the potential plot ID 441 is generated, the record is linked to the candidate plot at 442, and the polygon 444 defining area 903 is stored.

At step 805 a question is asked as to whether there is another edge of the building polygon, and if this question is answered in the affirmative then control is returned to step 801 and the next edge is selected. If the question is answered in the negative then all the edges have been considered, and a number of potential plots have been added to table 404.

In the example shown in FIG. 9, candidate plot 701 includes four potential plots, one on each side of building 703: plots 903, 906, 907, and 908. For example, plot 907 has been generated by selecting an edge 909 of building polygon 704, and extrapolating it to generate a line 910 that intersects with land boundary 702. Line 910 segments land boundary 702 to create two areas 907 and 911. Area 907, which does not contain building polygon 704, is identified as a portion of the land polygon which is of interest as a potential plot. Its polygon 444 is stored for display.

More than four potential plots cannot be generated in this embodiment. However, fewer than four is likely. For example, a semi-detached house would have three potential plots, at the front, rear and side; a terraced house would have two, at the front and rear; houses with no front garden would not have a front plot. In exceptional circumstances, a building may take up the entire plot and no potential plots are generated.

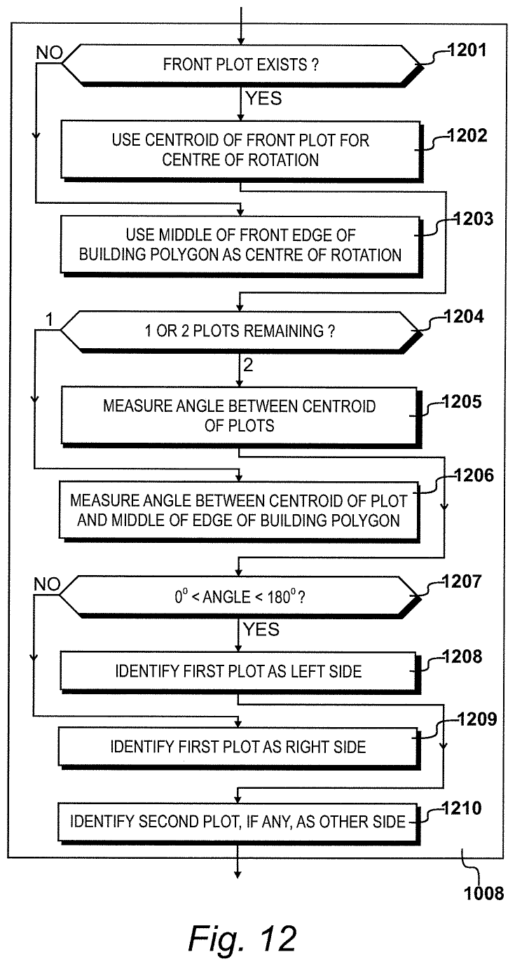

### FIGS. 10, 11a and 11b

Step 603 at which candidate plot 701 is orientated is detailed in FIG. 10 and illustrated in FIGS. 11a and 11b. As previously explained, it is important to orientate a candidate plot to ascertain which are the front, rear and side plots. Once this has been carried out, the potential plots will be processed further in a different way for each type of plot. In addition, the orientation allows the build line to be identified, which is roughly consistent with the front of building 703; in general, construction is not permitted in front of the build line in a street scene.

At step 1001 the road link for the building is identified. This is the feature ID of the road that the building stands on, i.e. its postal address, and it is stored as an associated ID 426 in the feature data 433. Therefore, using the associated ID 426, the road link can be found in feature data 402 in the imported base data 203. Its coordinates are stored in feature polygon field 422 but represent a line rather than a polygon, and these are imported into stored in candidate plot data 403 as road link 436, along with any additional relevant data such as the name of the road.

An assumption is made that the front of the building faces the road. This may not be the case aesthetically, as the “front door” may be on the side of the house, but in terms of identifying the front plot and the build line, the side facing the road is the front.

Therefore, at step 1002 the distance is measured from road link 436 to the centroid of all the potential plots identified at step 602. This is illustrated in FIG. 11a. Line 1101 represents the road link, and the overlapping plots 903, 906, 907 and 908 are shown. Line 1102 shows the distance from line 1101 to the centroid 1104 of plot 903. Similarly, line 1105 shows the distance to the centroid of plot 908, line 1106 shows the distance to the centroid of plot 906 and line 1107 shows the distance to the centroid of plot 907.

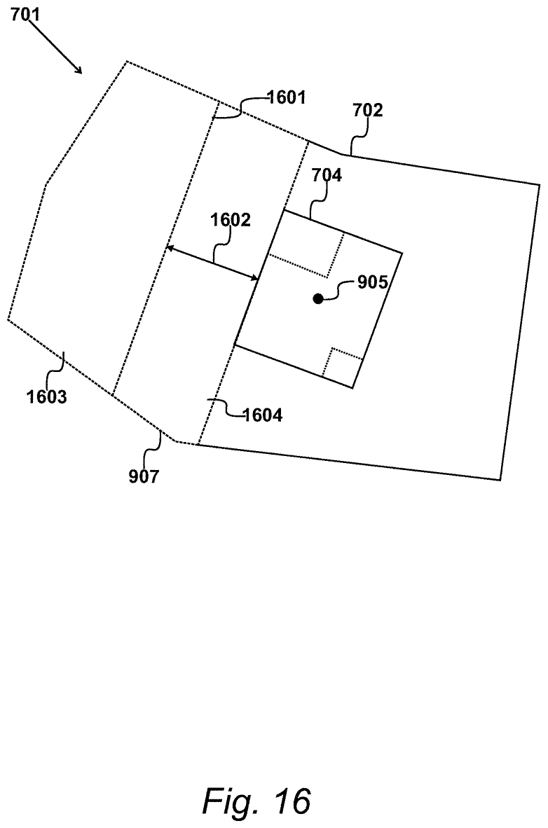

At step 1003, the plot that has the longest measured distance is identified as the rear plot. Referring to FIG. 11a, this is plot 908, and in this illustration, it can be seen that this is in fact the plot at the rear of building 703. The plot type 445 for this potential plot is updated with the information that it is a rear plot. At this point, if there is in reality no rear plot then a side plot or even a front plot may be incorrectly identified as a rear plot. However, as will be understood when the processing of a rear plot is discussed with respect to FIG. 15, such a plot will be discarded as having no area, and a house with no rear garden is unlikely in any case to be suitable for building.

At this point, building polygon 704 can be orientated: the two corners adjacent to the rear plot must be the rear corners, and therefore the other two corners are the front corners. This information is stored with the building polygon at 434 in candidate plot data 403.

A question is then asked at step 1005 as to whether there is another potential plot for this candidate plot. If the house has only a back garden, then there is only a rear plot and therefore this question is answered in the negative. However, if the house has a front or side garden, then this question is answered in the affirmative and at step 1006 the plot that has the shortest measured distance is identified as the front plot, and this is stored in the plot type 445.

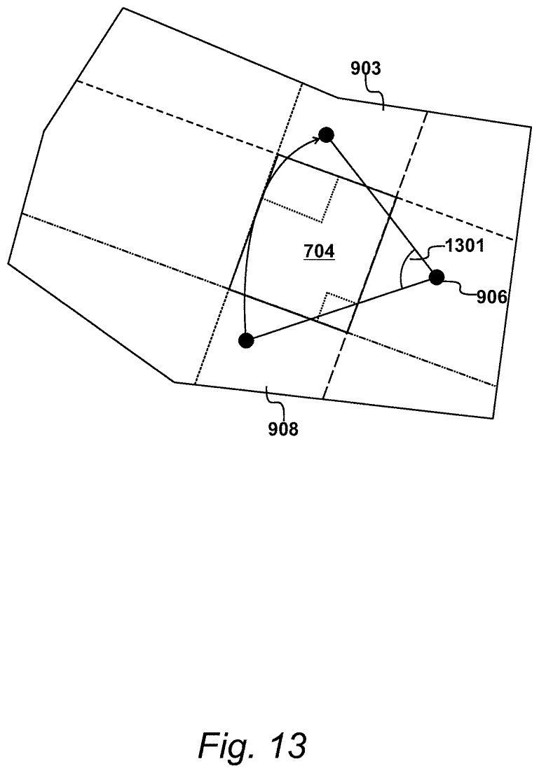

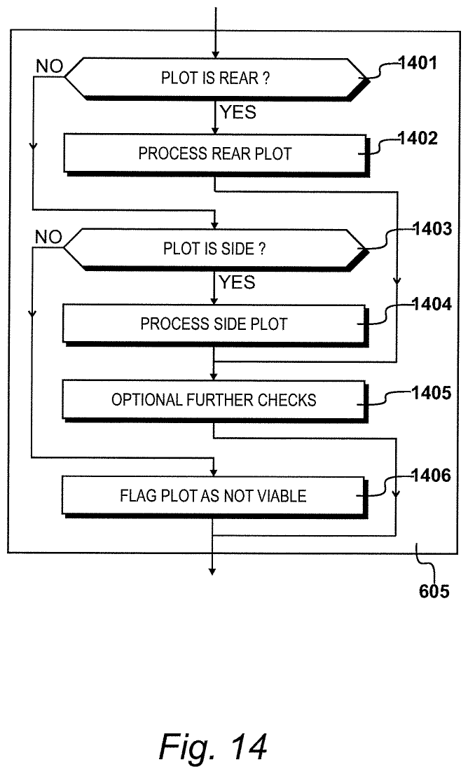

At step 1007 a question is asked as to whether there is another potential plot for this candidate plot. This will be answered in the negative if the house has no side plots, but if it is answered in the affirmative then at step 1008 the remaining plots are identified as left or right, as will be described further with reference to FIGS. 12 and 13.

At this point, and if either of the questions asked at step 1005 or 1007 is answered in the negative, then the build line is identified at step 1009, as shown in FIG. 11 b. The distance from each of the front corners of building polygon 704 to the build line 1101 is measured, and the average of this is stored as build line distance 437. This distance is not used in the further processing of potential plots, but may be displayed to users along with other data relating to potential plots.

Thus each portion of the candidate plot identified to be of interest as a potential plot is identified as being at the front, back or side of the candidate plot. This is done by obtaining geospatial data, which in this case is road link data 436, identifying a road associated with the building. The data includes a line, which in this example is line 1101. The distance between each portion and the line is calculated, and these distances are used to identify the portions as being at the front, back or side of the candidate plot.

### FIGS. 12 & 13

Step 1008, at which left and right side plots are identified, is detailed in FIG. 12. At step 1201 a question is asked as to whether a front plot has been identified for this candidate plot, and if this question is answered in the affirmative then at step 1202 a centre of rotation is defined to be the centroid of the front plot. Alternatively, if there is no front plot, then at step 1203 the middle of the front edge of the building polygon 704 is defined as the centre of rotation.

At step 1204 a question is asked as to whether there are one or two plots remaining (in this embodiment, there cannot be more than four in total). If there are two, then at step 1205 the angle from the centroid of one plot to the other plot (chosen arbitrarily) is measured clockwise using the previously-identified centre of rotation. If there is only one remaining plot, then at step 1206 the angle is measured between its centroid and the middle of the adjacent edge of building polygon 704.

At step 1207 a question is asked as to whether this measured angle is between 0° and 180°. If this question is answered in the affirmative then at step 1208 the first plot, i.e. the plot measured from, is identified as a left side plot. An illustration of this can be seen in FIG. 13. The centroid of front plot 906 is used as the centre of rotation, and the angle between the centroids of plot 908 and plot 903 is measured as shown at 1301. This is an acute angle meaning that the plot measured from, i.e. plot 908, is the left side plot. If the angle had been measured from the centroid of plot 903, then because the measurement is clockwise the angle would have been obtuse. In that case, the question answered at step 1207 is answered in the negative, and at step 1209 the first plot, i.e. the plot measured from, is identified as the right-side plot.

In the case of only a single plot, the same principle holds and the plot is identified either as a left side plot if the angle is acute and has a right-side plot of the angle is obtuse.

At step 1210 the other plot, if there is one, is identified as the opposite side to the one already identified. For example, in FIG. 13 plot 903 is identified as the right side since plot 908 has been identified as the left side.

Step 603 is now complete, and the candidate plot has been orientated so that all potential plots are labelled as front, rear, left side or right side.

Thus there is herein described a method in which base geospatial data relating to plots of land and buildings is obtained, which in this example is base data 401 and 402. Using this base geospatial data, data defining a candidate plot is identified, which in this example is data 403. This data comprises first geospatial data describing a plot of land, which in this example is polygon 411 defining the land boundary 702, and second geospatial data describing at least one building standing on it, which in this example is polygon 412 defining building 703. The building has an unknown real-world orientation, meaning that it is orientated in the real world but this orientation is not present in the geospatial data. A first polygon is created, using the second geospatial data, that encompasses the building, which in this example is building polygon 704. Using the first geospatial data, a portion polygon that is not in the first polygon is identified, which in this example is polygon 444. The portion polygon defines a portion of the plot of land, for example one of plots 903, 906, 907 or 908, and its orientation with respect to the real-world orientation of the building is identified. The portion polygon and data relating to the portion, such as data 403 and 404, are stored for display, in this example in live database 107.

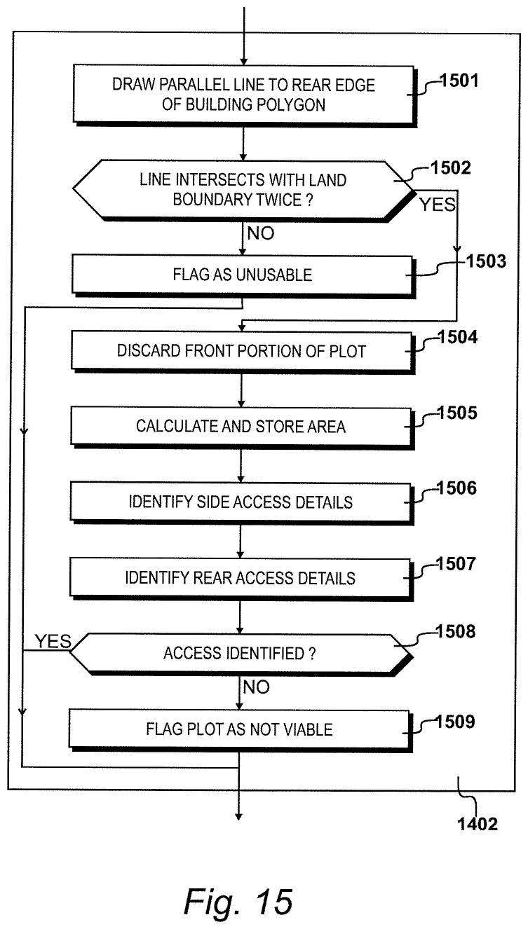

### FIG. 14

It is now necessary to identify the usable portion of each plot, and determine whether there is access to the plot, as this is essential for a building to be constructed on it.

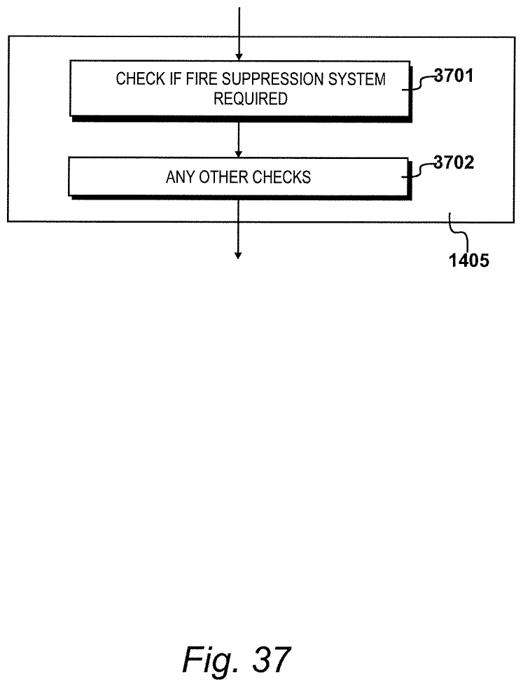

FIG. 14 details step 605 at which a potential plot is processed further, to calculate its area and identify access details. At step 1401 a question is asked as to whether the potential plot being considered is a rear plot, as indicated by its plot type 445, and if this question is answered in the affirmative then it is processed as a rear plot at step 1402. If it is answered in the negative, then at step 1403 a second question is asked as to whether it is a side plot, and if this question is answered in the affirmative then it is processed as a side plot at step 1404. Following both steps 1402 and 1404, optional further checks on the rear or side plot may be carried out at step 1405, as will be described further with respect to FIG. 37.

If the second question is also answered in the negative, then the plot is a front plot, and in this embodiment it is not processed further and at step 1406 is flagged as not viable in plot type 445. In this embodiment, front plots are not considered viable because it is usually not possible to build in front of the build line. However, the potential plot is not discarded from the database, as it may be useful for other purposes.

The processing of the rear and side plots will now be described with reference to FIGS. 15 to 22.

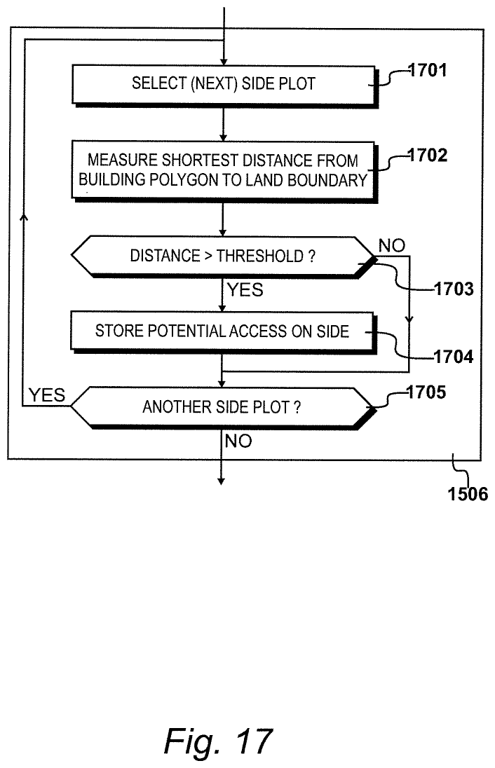

### FIGS. 15 and 16

FIG. 15 details step 1402, at which a potential plot is processed further if it is a rear plot. In general, there exist local planning laws regarding the distance any potential plot must be from the rear of the existing building 703. This distance is stored as a variable within the database, and may be automatically selected depending on the location of the plot, and/or may be modifiable by an administrator of data generation station 105.

Thus, at step 1501 a line is drawn parallel to the rear edge of the building polygon 704, at the identified distance away, which in this example is 12.5 metres. This is shown in FIG. 16 as line 1601, which is a distance 1602 away from the rear edge of building polygon 704, the building polygon having been orientated during the orientation of a candidate plot at step 603.

At step 1502 a question is asked as to whether this line intersects with the land boundary 702 exactly twice. If this question is answered in the negative then at step 1503 the type 445 of the potential plot is updated with a flag to indicate that it is unusable. If there are no intersections with the land boundary, then there is no portion of the plot that is more than the identified distance away from building polygon 704; if there are more than two intersections then removing the portion of the plot closest to the building has left two or more areas which cannot be automatically processed. They may however be of interest to another process in the future, and therefore the potential plot is not discarded. It should be noted that flagging a plot as not a potential plot is not the same as flagging it as not viable. A front plot or a plot without access may be marked as not viable, but it may be useful for further processing.

If there are precisely two intersections, then the rear plot can be processed. As shown in FIG. 16, line 1601 bisects plot 907 into two portions, rear portion 1603 and front portion 1604. At step 1504 the front portion of the plot is discarded. This is done by measuring the distances from the centroids of the two portions to the centroid 905 of building polygon 704. The portion with the longer measurement must be the rear plot, and the coordinates of this portion are stored as polygon 444 for the potential plot, overwriting the previously-stored polygon. At step 1505 the area of the potential plot is calculated from the polygon 444 and stored at 443.

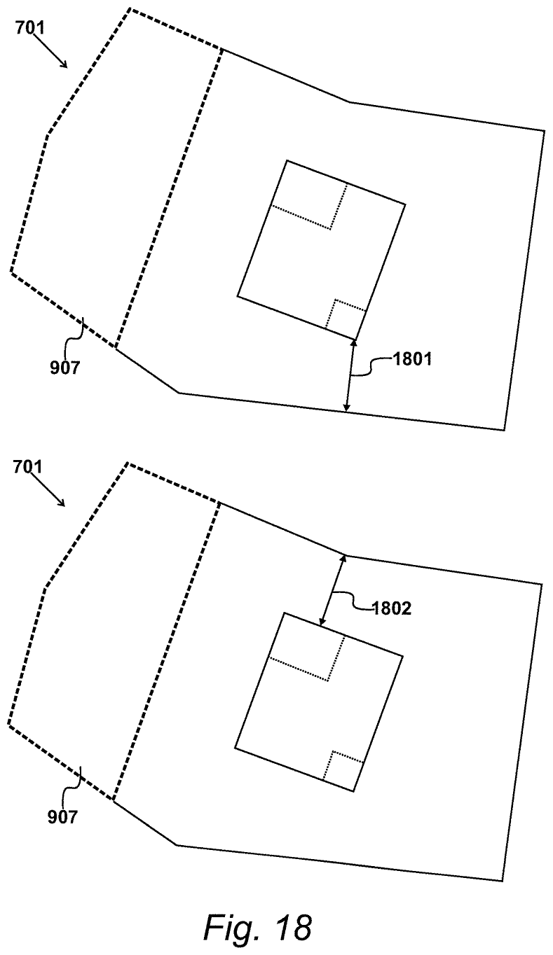

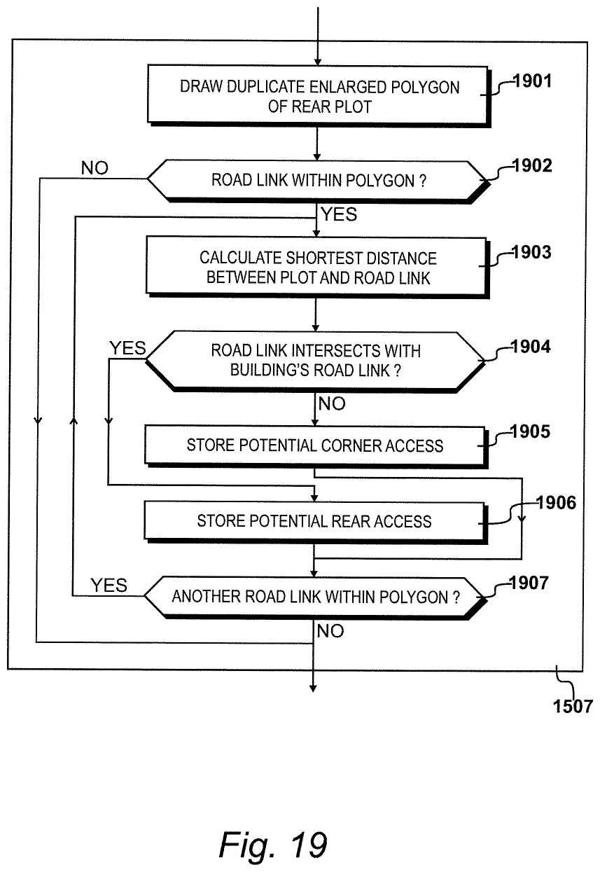

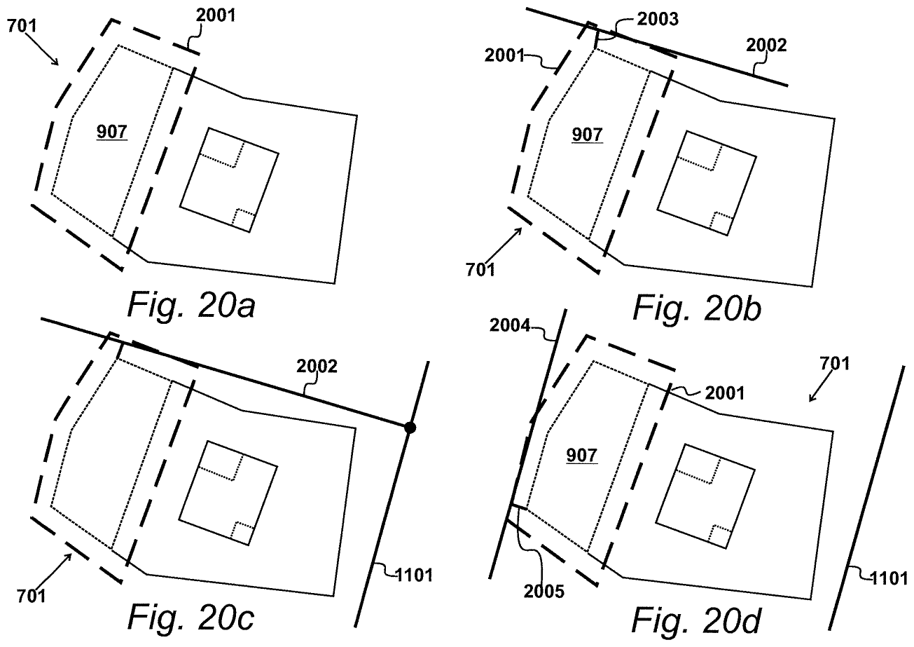

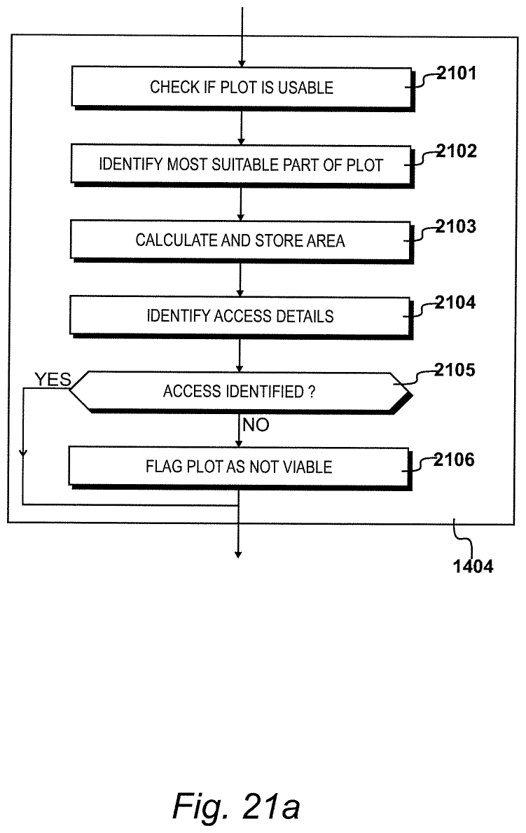

For this rear plot to be viable, it must have vehicular access to a road, either down the side of the building or at the rear. Therefore, at step 1506 side access details are identified, as will be described further with reference to FIGS. 17 and 18, and at step 1507 rear access details identified, as will be detailed further with respect to FIGS. 19 and 20. At step 1508 a question is asked as to whether any access details, whether side or rear, have been identified, and if this question answered in the negative then at step 1509 the plot is flagged as not viable. This means that it will not be displayed to users as a plot that may be built on. However, it may be combined with adjacent potential plots to create an assembled plot that does have access, and therefore it is saved for further processing.

At this stage, or following step 1503, or if the question asked at step 1508 is answered in the affirmative, then step 1402 is completed. The rear plot has been processed and either flagged as a viable plot with access, flagged as a non-viable plot that may be suitable for further processing, or flagged as unusable. These flags are all stored in type location 445, which may be a number of fields or links to other tables.

Thus a portion polygon defining a portion of a plot of land, identified as a potential plot, may be reduced in size. In this example, the polygon 444 relating to rear plot 907 is reduced by generating a second line, which in this example is line 1601, that is parallel to and at a first pre-determined distance from an edge of the building polygon, and that intersects with the second polygon defining the land boundary. This line segments the portion polygon to create at least two areas, and the area closest to the edge is discarded from the polygon.

### FIGS. 17 and 18

Step 1506, at which side access details for a rear plot are identified, is detailed in FIG. 17 and illustrated in FIG. 18. If there is side access, it must be through a side plot, and therefore at step 1701 the first side potential plot belonging to the candidate plot is identified. If there are no side plots, then step 1506 is over and there is no side access. At step 1702 the shortest distance from the building polygon 704 to the land boundary adjacent to the side plot is measured. This is illustrated in FIG. 18 for both side plots in the example; rear plot 907 is shown with its redefined polygon. If the left plot 908 is considered first, then the shortest distance is shown by line 1801.

At step 1703 a question is asked whether this measured distance 1801 is greater than a threshold. The minimum distance between a building and its land boundary for vehicular access is set by local planning laws, and is stored in the database. Different values for different planning authorities may be stored, and the appropriate value may be automatically selected and/or changed by an administrator of data generation station 105. In this example, the threshold is 3.2 metres.

Thus, if the shortest measured distance between the building and the land boundary is greater than this threshold, then at step 1704 access details are added to location 446 for this potential plot, indicating that there is access on the left or right side, according to the side plot being considered.

At step 1705 a question is asked as to whether there was another potential side plot in the candidate plot, and if this question is answered in the affirmative then control is returned step 1701 and the next side plot is selected. In FIG. 18, the right side plot is identified and the distance 1802 measured. Alternatively, step 1506 is complete and either side access details have been identified, or they have not.

This process determines whether there is access from a rear plot through a side plot to the front plot. It is assumed that if there is access to the front plot, then there is access to the road.

### FIGS. 19, 20a, 20b, 20c and 20d

The process now turns to consideration of access at the rear, and step 1507 is further detailed in FIG. 19 and illustrated in FIGS. 20a to 20d. Identifying potential rear access points involves determining whether there are any roads adjacent to the rear potential plot.

At step 1901 the polygon 444 of the rear potential plot 907 is duplicated and enlarged. In this example, the enlargement is by 5 metres in all directions; this is a user-configurable variable, and may be altered depending on the typical width of local pavements and roads. Referring to FIG. 20a, the polygon defining plot 907 has been duplicated and enlarged as polygon 2001.

At step 1902 a question is asked as to whether there exists a road link that intersects with polygon 2001. This involves searching feature data 402 for features identified as roads whose defining line, stored at polygon 422, intersects with polygon 2001. If this question is answered in the affirmative, then this road is adjacent to plot 907, and therefore at step 1903 the shortest distance between the rear potential plot and this road link is calculated. As shown in FIG. 20b, a road link 2002 has been found that intersects with polygon 2001; the shortest distance between the polygon defining plot 907 and road link 2002 is shown as line 2003. The plot therefore has rear access to a road. It now needs to be determined what type of rear access this is.

At step 1904 a question is asked as to whether this road link intersects with the building's road link, stored at 436 in the candidate plot 403. As illustrated in FIG. 20c, road link 2002 intersects with building road link 1101 meaning that the plot is on a corner. If this question is answered in the affirmative then at step 1905 the access details, including the road link 2002 and the coordinates of shortest distance 2003, are stored as potential corner access details in access data 464 for this potential plot.

Conversely, if the road link does not intersect with the building's road link, then at step 1906 similar details are stored but marked as potential rear access. This is illustrated in FIG. 20d, where road link 2004, which intersects with enlarged polygon 2001, does not intersect with building road link 1101.

Road link 2004 and the shortest distance 2005 between plot 907 and road link 2004 are therefore stored in access data 446 as potential rear access.

At step 1907 a question is asked as to whether there is another road link within the polygon. In the example shown in the Figures, this question would be answered in the affirmative and control returned to step 1903 to consider this new road link. Alternatively, step 1507 is completed.

Thus, at the conclusion of steps 1506 and 1507, a maximum of two options for side access may have been identified, and any number of options for rear access. Alternatively, it is possible that no access has been identified, in which case the plot is not viable.

This completes the processing of a potential rear plot. Consideration returns to any identified side plots.

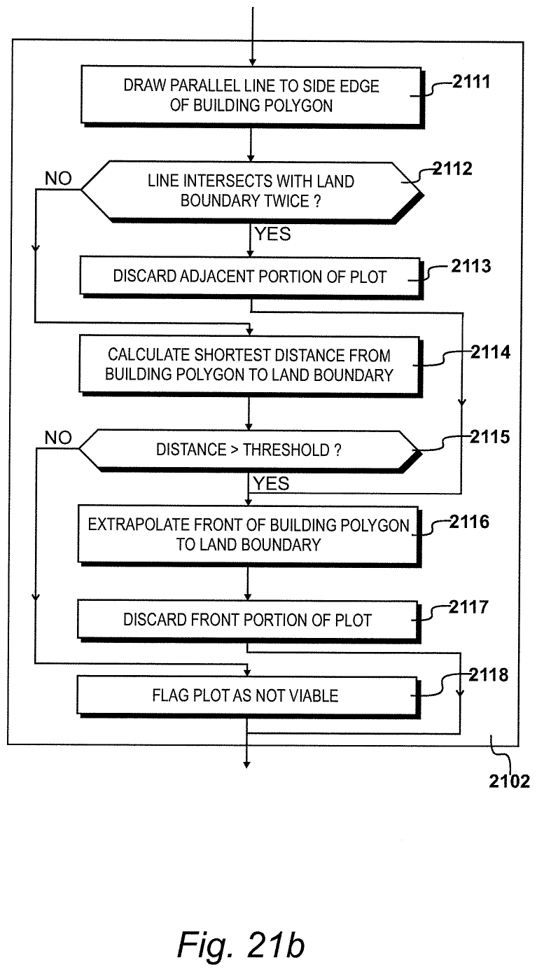

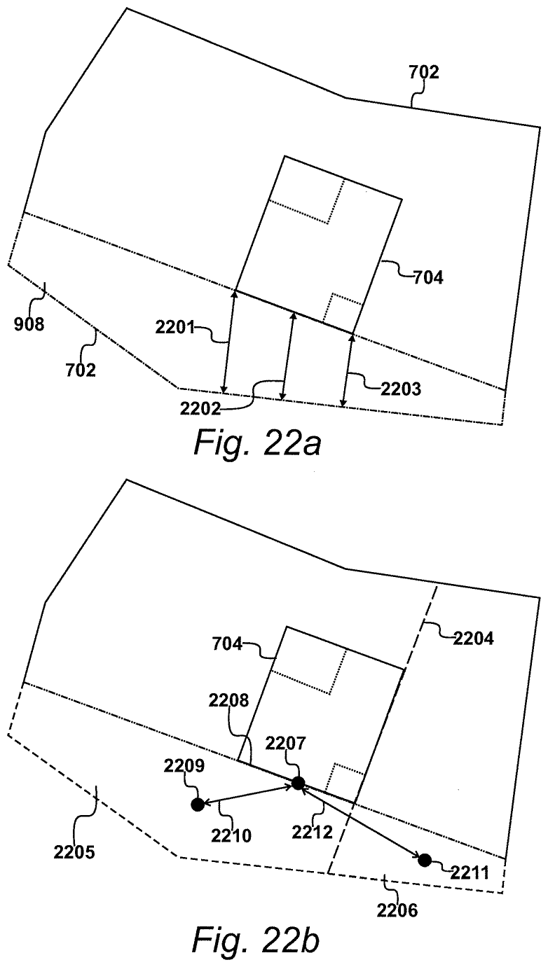

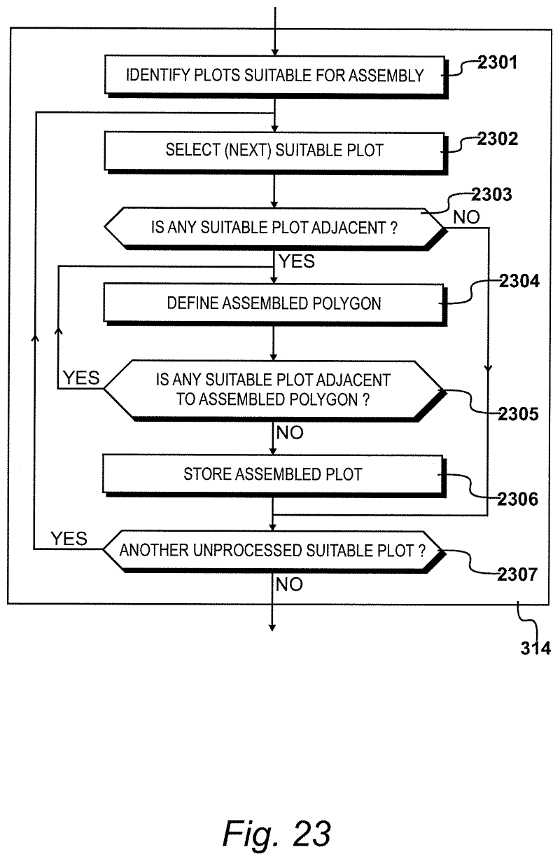

FIG. 21aStep 1404 at which a side plot is processed is detailed in FIG. 21a, further detailed in FIG. 21b, and illustrated in FIGS. 22a and 22b. For a side plot, it is necessary to identify whether the plot is wide enough to accommodate a building. It is assumed that there is potential access at the front of the building. Other considerations include whether the plot is on a bend or a corner of the road.

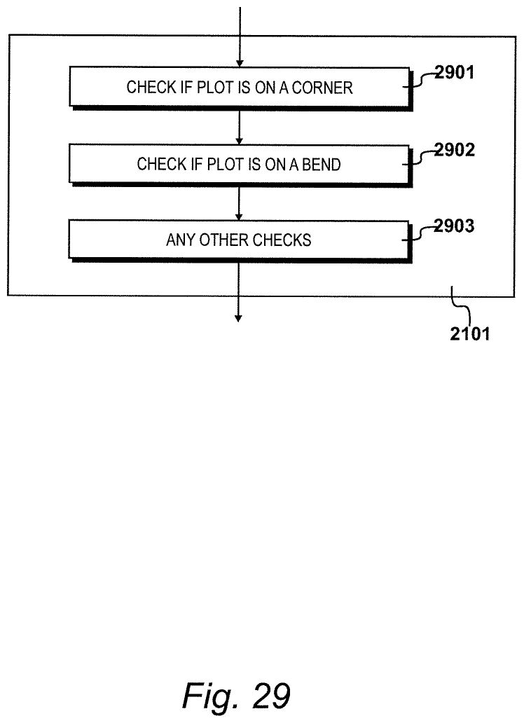

At step 2101, initial checks are carried out as to whether the plot is usable. This will be further described with reference to FIGS. 29 to 34b. If the plot is flagged as unusable during this step, then step 1404 will be complete for this plot.

If the plot was not flagged as unusable, then at step 2102 the most suitable part of the plot to be used is identified, as will be further described with reference to FIG. 21b. This may be the whole plot, or part of it may be discarded before continuing. At step 2103 the area of the plot is calculated and stored in field 443.

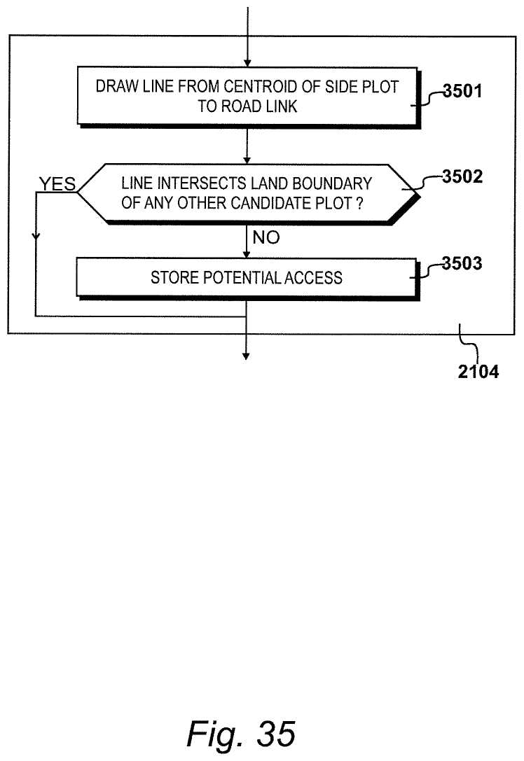

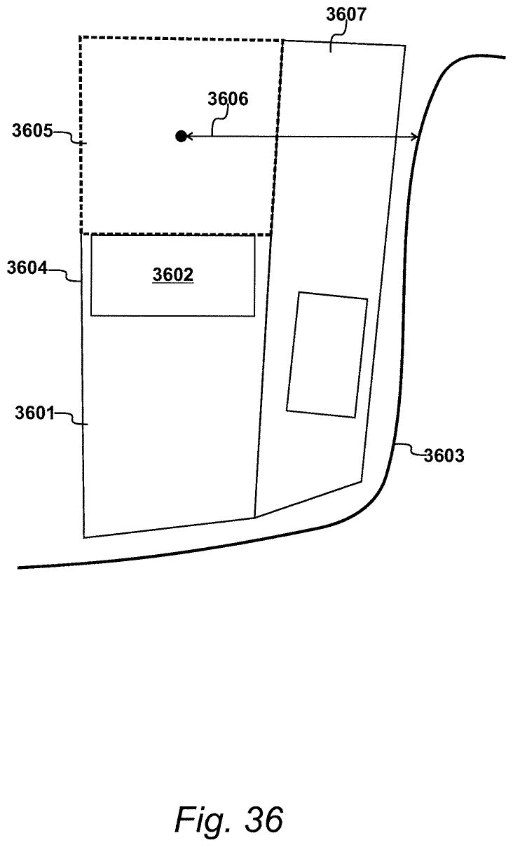

For this side plot to be viable, it must have vehicular access to a road. Many side plots have direct access to the road in front of the house, but this is not always the case. Therefore, at step 2104 access details are identified, as will be described further with reference to FIGS. 35 and 36, and at step 2105 a question is asked as to whether any access details have been identified. If this question answered in the negative then at step 2106 the plot is flagged as not viable. This means that it will not be displayed to users as a plot that may be built on. However, it may be combined with adjacent potential plots to create an assembled plot that does have access, and therefore it is saved for further processing.

At this stage, and if the question asked at step 2105 is answered in the affirmative, then step 1402 is completed.

### FIGS. 21b, 22a and 22b

Step 2102, at which the most suitable part of the plot is identified, is detailed in FIG. 21b and illustrated in FIGS. 22a and 22b. The side plot is processed differently depending on its size. For a wide side plot, it would be most appropriate to build away from the building, but for a narrow side plot it would be necessary to build closer.

First, at step 2111, a line is drawn parallel to the adjacent side edge of the building polygon 704, at a specified distance away, which in this example is 12.5 metres and is user-configurable. At step 2112 a question is asked as to whether this line intersects with the land boundary 702 exactly twice. If this question is answered in the affirmative then the plot is wide enough to be bisected by the line into two portions. In this case, the portion of the plot closer to the building is discarded, by measuring the distances from the centroids of the two portions to the centroid 905 of building polygon 704, selecting the portion with the longer measurement, and storing the coordinates of this portion as polygon 444 for the potential plot, overwriting the previously-stored polygon.

Alternatively, if the line drawn at step 2111 intersects more than twice with the land boundary or not at all, then the line does not bisect the side plot, meaning that the plot is narrow. It is therefore necessary to check whether it is wide enough to build on.

At step 2114, the shortest distance from building polygon 704 to the land boundary 702 is identified for the side plot under consideration. As shown in FIG. 22a, side plot 908 is being considered. The shortest distance is discovered by taking three measurements from the edge of the building polygon 704, one at each end of the edge and one in the middle, as shown by arrows 2201, 2202 and 2203. The shortest of these distances is identified, which in this example would be distance 2203, and at step 2115 a question is asked as to whether this distance is greater than a threshold. As with the other thresholds used in this process, this may vary according to local planning laws, and is stored in the database (not shown). The relevant threshold may be automatically identified based on the location of the candidate plot, and/or may be configurable by an administrator. In this example, the threshold is 7.5 metres. This is the minimum width of a side plot in order for it to be viable.

Thus, if this question is answered in the affirmative, and following step 2113, then at step 2116 the front edge of building polygon 704 is extrapolated to the land boundary 702. This is shown in FIG. 22b as line 2204, which bisects plot 908 into portions 2205 and 2206.

At step 2117 the front portion is discarded, as it is not usually possible to build in the front garden of a residential building. This is done by measuring the distances from the centroids of each portion to the middle of the edge of building polygon 704 adjacent to the side plot. Thus, in the example shown in FIG. 22b, the distance is measured from the midpoint 2207 of the edge 2208 of building polygon 704 to the centroid 2209 of portion 2205, as shown by line 2210. A similar measurement is made to the centroid 2211 of portion 2206, as shown by line 2212. The shortest measurement is 2210, indicating that portion 2205 is the rear portion. Thus, the coordinates of rear portion 2205 are saved as polygon 444 for this potential plot, overwriting the previous coordinates of plot 908. Plot 908 is therefore redefined using the polygon of portion 2205.

If the question asked at step 2115 is answered in the negative, to the effect that the shortest distance between the building polygon and the land boundary is less than the relevant threshold, then at step 2118 the plot is flagged as not viable because it is too narrow for construction. Following either step 2117 or step 2118, step 2102 is complete.

Control then passes to step 2103 and the area of the plot is calculated. At this stage, it may be necessary to refine the side plot slightly. For example, if the plot was redefined at step 2113 because it is wide, but the eventual calculated area is small, then it might be a candidate for re-evaluation as a narrow plot.

At he completion of step 1404, the side plot has been processed and either flagged as a viable plot with access, flagged as a non-viable plot that may be suitable for further processing, or flagged as unusable.

At the completion of step 502 detailed in FIG. 6 and further described in subsequent Figures, a candidate plot has been processed to identify all potential plots within it, and they have been identified as viable or not. In other embodiments, the process could stop here, with the new and updated potential plots being collated and pushed to one or more live databases. However, in this embodiment plots are further processed in order to identify potential assembled plots at step 503, as will be subsequently described.

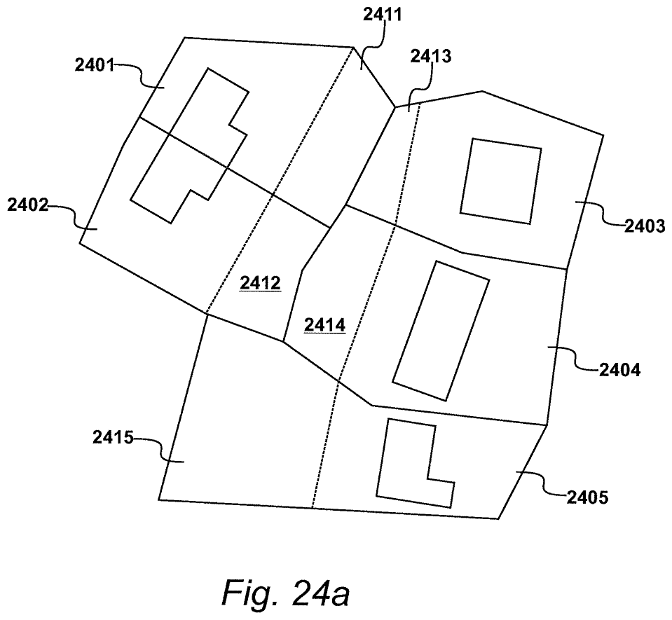

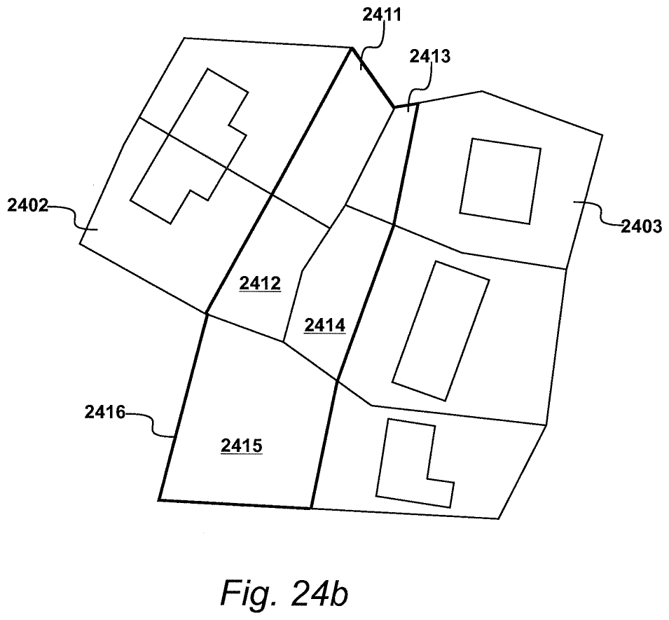

### FIGS. 23, 24a and 24b

Once all potential plots have been generated at step 313, process 205 determines whether any of these can be assembled to create larger plots, referred to as assembled plots. This is carried out at step 314, detailed in FIG. 23, and illustrated in FIGS. 24a and 24b.

FIG. 24a shows five candidate plots with their land boundaries shown in solid lines: candidate plots 2401, 2402, 2403, 2404 and 2405. Each of these has been processed during step 313, and a number of potential rear plots have been identified, shown with dashed lines. Potential plot 2411 is at the rear of plot 2401, potential plot 2412 is at the rear of plot 2402, potential plot 2413 is at the rear of plot 2403, potential plot 2414 is at the rear of plot 2404, and potential plot 2415 is at the rear of plot 2405.

In this example, potential plots 2411, 2414 and 2415 do not have any access and are therefore not viable. Plots 2412 and 2413 do have potential side access, but might be considered too small to build on. However, when viewed as a single large plot made up of potential plots 2411 to 2415, there is a considerable usable area that does have access. Process 105 therefore automatically identifies such assembled plots.

At step 2301, plots suitable for assembly are identified. In this embodiment, this includes all side and rear plots, whether or not they are flagged as viable and whether or not they have access. Plots marked as unusable are not included, nor are front plots. However, in other embodiments such plots could be included.

At step 2302 the first of these identified suitable plots is selected, and at step 2303 a question is asked as to whether any other suitable plot is adjacent to it. This is done by querying the set of suitable plots to find those with adjacent polygons 444.

If an adjacent plot is found, then at step 2404 an assembled polygon is defined by merging the two adjacent polygons. At step 2505 a question is asked as to whether there is any further suitable plot in the identified list that is adjacent to this assembled polygon; this is done in the same way as at step 2303. If the question is answered in the affirmative then control is returned to step 2404 and the assembled polygon is redefined by merging it with this adjacent polygon.

Eventually, the question asked at step 2505 will be answered in the negative, to the effect that there is no further suitable plot that has a polygon adjacent to the assembled polygon, and therefore at step 2606 the assembled plot is stored. Referring back to FIG. 4b, assembled plot data 405 includes an assembled plot ID, links to the potential plots it encompasses 452, the area of the assembled plot 453, and its polygon 454 (as defined at step 2404). Access data 455 is copied from the access data for the encompassed potential plots.

At this stage, and if the question asked at step 2303 is answered in the affirmative, then a question is asked as to whether there is another suitable plot that has not yet been considered in this process, and if this question is answered in the affirmative then control is returned to step 2303 and the next suitable plot is selected. Alternatively, all the suitable plots have been considered and all possible assembled plots have been generated, and step 314 is concluded.

The assembled plot generated in this example is shown in FIG. 24b at 2416, and it is an assembly of potential plots 2411 to 2415. Thus, in the record in assembled plot data 405, the IDs of these potential plots are stored at 452. Coordinates defining polygon 2416 are stored at 454, and its area is stored at 453. Access is potentially available down the sides of plots 2402 or 2403, and these details are stored in access data 455.

It may be the case that none of the potential plots making up the assembled plot have any access. However, this does not mean that the assembled plot is not viable, as it might be possible to purchase the entirety of a plot and knock down the building standing on it for the purposes of access. Therefore, all assembled plots are shown to users, even those without any access.

At the conclusion of step 314, data generation process has concluded an iteration of generating working data 206, and waits for another update. Data collation process 205 receives an update notification at step 321, and starts an iteration of updating the live databases.

Thus, if the method is carried out for each of a number of candidate plots, a large number of potential plots are generated, each defined by a portion polygon such as polygon 444. A set of portion polygons that are substantially adjacent to each other define a continuous real-world area, and can be used to generate an assembled polygon, such as polygon 454. This assembled polygon and associated data, such as data 405, are stored, for example in live database 107, for display.

### FIG. 25

Once data generation process 105 has completed the generation of potential plots and assembled plots in working database 206, data collation process 205 identifies changes to previously-generated data and pushes these changes to live database 207, and any other live databases such as that on server 107.

Live database 207 and user database 208 are illustrated schematically in FIG. 25. Live database 207 includes two tables, potential plot data 2501 and assembled plot data 2503. These are collations of data from working database 206. Working database 206 contains data that will not be shown to the end user, and therefore this can be omitted from the live database; in addition, live database 207 contains some data that is useful for display to a user but is not necessary for the data generation process. In addition, working database 206 is normalised and indexed to optimise the data generation process, whereas live database 207 is optimised for user queries. The two databases may even be in different formats.

Potential plot data 2501 includes a potential plot ID 2511, area 2515, polygon 2516, plot type 2517, and access data 2518, all of which are imported from locations in potential plot data 404 in working database 206. In addition, for each record, relevant data from candidate plot data 403 is imported: candidate plot ID 2512, land data 2513, feature data to 2514, road link 2519, and build line distance 2520. These are imported into each potential plot entry rather than stored in a linked table, to assist with versioning which will be described further below. In addition, potential plot data 2501 contains new data inserted by data collation process 105: global coordinates 2521, attributes 2522 and versioning data 2523, all of which will be described further below.

Assembled plot data 2503 contains data imported from assembled plot data 404 in working database 206, and includes assembled plot ID 2531, potential plot IDs 2532, area 2533, polygon 2534 and access data 2535, which are a copy of fields 451 to 455 in table 405. In addition, there is versioning data 2536. Potential plots 2532 link to potential plot ID 2511 in table 2501.

Therefore, live database 207 contains all the information necessary for users to search for assembled plots, view details of plots, including diagrams of the plot area and indications of access, and save plots in their user profile to access again at a later time. Thus, user database 208 includes a user data table 2504, which at its most basic level includes user details 2541 and saved plots 2542. User details 2541 includes all the details necessary for the user, including for example logon details, subscription details, and so on. Saved plots 2542 is a list of all potential plots and assembled plots in which the user is interested, and therefore links to potential plot ID 2511 and assembled plot ID 2531.

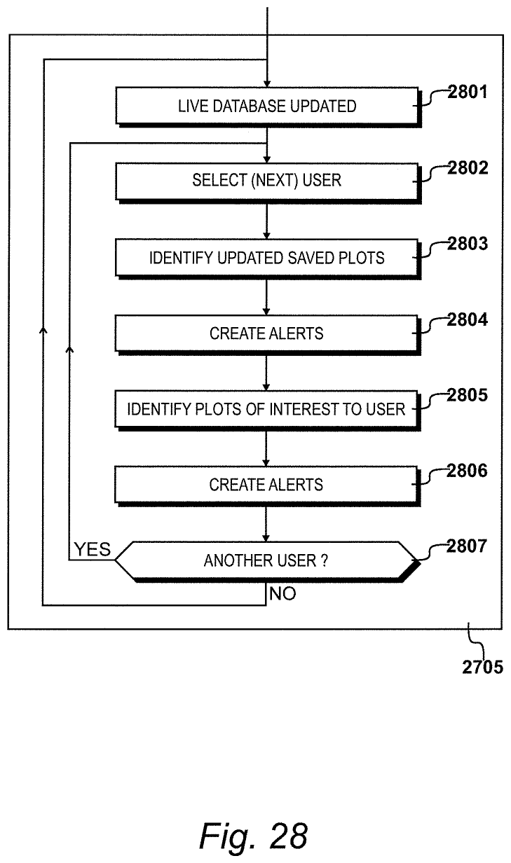

Because of the capability for users to save plots, it is important that when live database 207 is updated continuity is maintained. In other embodiments data collation process 205 could simply overwrite all the records in live database 207. However, this would lead to an unsatisfactory experience for users who would find that their saved plots might be changed or deleted without warning. Thus, in this embodiment, data collation process 105 pushes changes to live database 207 and updates versioning data 2523 and 2536, in order to ensure a seamless experience for users. The versioning data can be used to indicate to users that a plot they are interested in has changed, as will be described further with reference to FIG. 28.

### FIG. 26

Update process 322 is detailed in FIG. 26. At step 2601 the process compares working database 206 with live database 207 to identify matching potential or assembled plots, using the candidate plot ID which is always the same on every re-generation of the working data. At step 2602 the first matching plot is selected and at step 2603 a question is asked as to whether the land data or feature data has changed. Such a change can be identified by comparing version numbers, which are stored in land data 432 and feature data 433 in the working database, and also in land data 2513 and feature data 2514 in the live database.

If this question is answered in the affirmative, to the effect that the land data or feature data was updated, then it is possible that the potential plots and subsequent assembled plots have also been updated, and therefore at step 2604 the plot in the live database is updated. This can be done by copying the current data into versioning data 2523 or 2536, creating a new record for the new data and using the versioning data to indicate which is the current version, and so on. There are many ways of storing versioning information, and any suitable method can be used. At step 2604 a question is asked as to whether there is another matching plot, and if this question is answered in the affirmative, or if the question asked at step 2603 is answered in the negative, then control is returned to step 2602 and the next matching plot is selected. Alternatively, the question is answered in the negative and all the matching potential and assembled plots have been compared and updated if necessary.

At step 2606 plots in working database that are unmatched in the live database are identified. These are new plots, and therefore at step 2607 they are imported into the live database. Along with data from working database 206, the process includes importing further data: global coordinates 2521 and attributes 2522.

Global coordinates 2521 are the longitude and latitude of the potential plot, obtained by converting polygon 2516 into a global system. This enables each potential and assembled plot to be shown on a map.

Attributes 2522 includes other data which may be useful, which may be derived from land data 401 or feature data 402, or may be derived from other locations 110. Examples of such attributes are whether the plot is in an area of special scientific interest, nature reserve or national park, its flood risk, the last resale value of the candidate plot, the building's listed status, previous uses of the land such as landfill, and so on. Further attributes may be calculated from data already in the potential plot data, such as the size of house or number of houses that could be built on the available area. Such data could be generated on the fly when serving user requests, but it may be more efficient to calculate it at this stage. Alternatively, such data could be calculated on the fly and then cached in live database 207 by server process 209.

At step 2608 plots in the live database that are unmatched in the working database are identified. These are plots that no longer exist, usually because the candidate plot has been altered. Thus, at step 2609 the versioning data for these plots in the live database is updated to indicate that these plots are deleted.

Step 322 is now complete. Data collation process 205 next pushes these changes out to any other live databases, such as that on server 107, at step 323.

The updating process described with respect to FIG. 26 is only one suitable method. Comparison and update of databases can be done in many ways, and the most efficient way may depend upon the type of database used and the capability of the processor. For example, it may be more efficient to discover all the changes and then push them to all databases, to compare candidate plots rather than potential plots, and so on. In addition, as has been previously described, in other embodiments data generation process may only consider candidate plots that have updated land data or feature data, in which case it would be assumed that all records in working data 206 need pushing to the live databases.

### FIG. 27

It has been described how data generation process 105 imports base data, generates working data, and updates the live databases with any changes. Server process 209 will now be briefly described, which is run by a processor on server 106.

Depending on the amount of data and number of users, it may be appropriate for server 106 to be a network of servers, possibly including a load manager and dedicated servers for different functions, and so on. It could run processes on one or more processors or on a distributed processing system. References to a processor therefore include any suitable architecture. FIG. 27 shows a highly simplified schematic which could be embodied in any server architecture, showing a number of processes which form part of server process 209.

Session maintenance process 2701 handles user logins, opens and maintains sessions, and handles session timeouts.

User details maintenance process 2702 updates user details 2541 as necessary, either in response to user requests or in response to internal requests such as a subscription being updated or expiring.

Request handler 2703 receives requests from users for data from live database 207, and serves data in reply.

Database maintenance process 2704 handles any necessary updates to live database 207 and saved plots 2542. For example, it ensures that the database is appropriately indexed, handles any caching required, flags corrupted data, and so on.

Finally, user notifications process 2705, which will be described further with respect to FIG. 28, notifies users of changes to their saved plots and recommends plots of interest.

### FIG. 28

FIG. 28 details user notification process 2705. It is initiated by receiving a notification that live database 207 has been updated by data collation process 205.

At step 2802 an active user is selected from user details 2541, and at step 2803 the process identifies whether any of the user's saved plots 2542 have been updated, as indicated by comparing versioning data 2523 or 2536 with versioning data in saved plots 2542. If there have been any updates, for example a plot has been changed or no longer exists, then the process creates one or more alerts at step 2804. An alert may be internal, so that the user is notified of the change on next logon or via an internal message, it may be a message sent by an external communication method such as email, text message, and so on, it may be a push notification to a user's device, or any other suitable form of notification.

At step 2805 new and updated plots that may be of interest to the user are identified and similar alerts are created at step 2806. This identification may be done in a number of ways. For example, the user may have saved search filters, there may be notification subscription options where a user selects certain criteria which are of interest, or alternatively the process may automatically identify potential plots for recommendation based on the user's search history and saved plots.

At step 2807 a question is asked as to whether there is another active user, and if this question is answered in the affirmative then control is returned to step 2802 and the next user is selected. Alternatively, all the users have been considered, and the process returns to step 2801 to wait for another update to live database 207.

### FIG. 29

Optional refinements of the above-described process are described with reference to FIGS. 29 to 39. In the real world, roads are often not straight and houses do not always line up neatly to create usable side and rear plots.

FIG. 29 details step 2101, at which optional checks are carried out on side plots to remove those which are not usable. If a candidate plot is situated at the corner of two roads, then a side plot will be adjacent to a road, and should therefore be treated as a front plot and flagged as not usable. In addition, the other side plot in the candidate plot is unlikely to be usable, because it will constitute a significant part of the building's garden. This is checked at step 2901.

Similarly, if a candidate plot is situated at a bend in a road or at the end of a hammerhead, then the side plot should also be treated as a front plot and flagged as unusable. This is checked at step 2902.

At step 2903 any other checks, not detailed herein, are carried out.

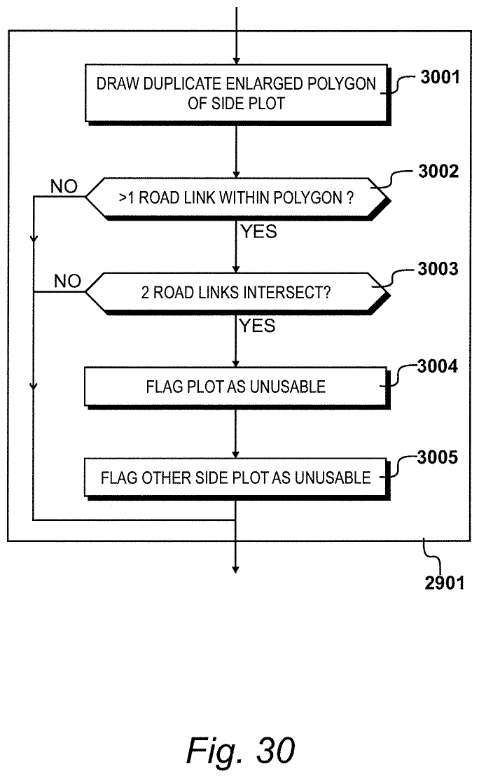

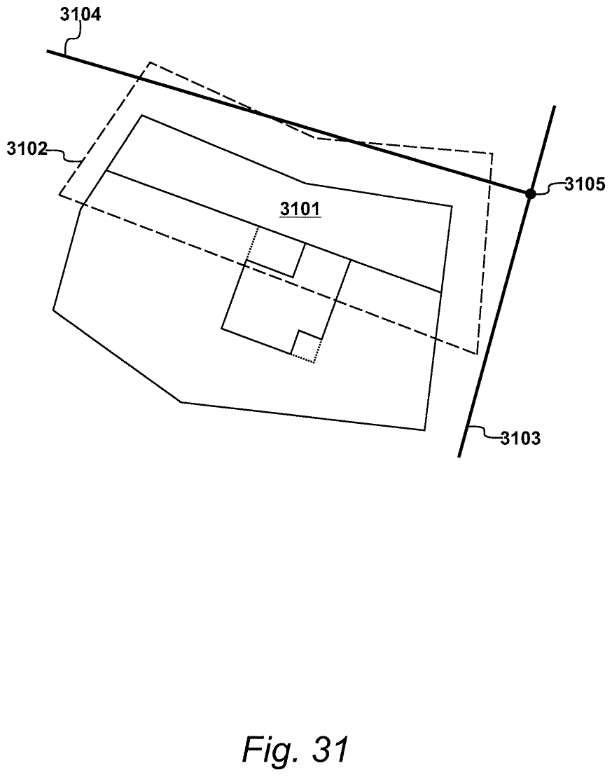

### FIGS. 30 and 31

FIG. 30 details step 2901, at which a side plot is rejected if the candidate plot is at a corner of two roads, illustrated in FIG. 31. At step 3001, the polygon defining the side plot is duplicated and enlarged by a suitable amount, usually the same as the amount used in step 1901 which in this embodiment is 5 metres and is a user-configurable variable. As shown in FIG. 31, side plot 3101 has been duplicated and enlarged to create polygon 3102.

At step 3002, a question is asked as to whether the enlarged polygon 3102 intersects with more than one road link. If this question is answered in the affirmative then a further question is asked at step 3003 as to whether any of these road links intersect. In the example of FIG. 30, polygon 3102 intersects with road links 3103 and 3104, which intersect at point 3105.

If the question asked at step 3003 is answered in the affirmative then the potential plot is on a corner, and it is flagged as unusable at step 3004. Further, at step 3005 any other side plot identified in this candidate plot is also flagged as unusable, even if it has already been processed. Step 2101 is then exited, without proceeding to step 2902, since the side plot is unusable.

At this point, and if either of the questions asked at steps 3002 or 3003 are answered in the negative, then step 2901 is concluded.

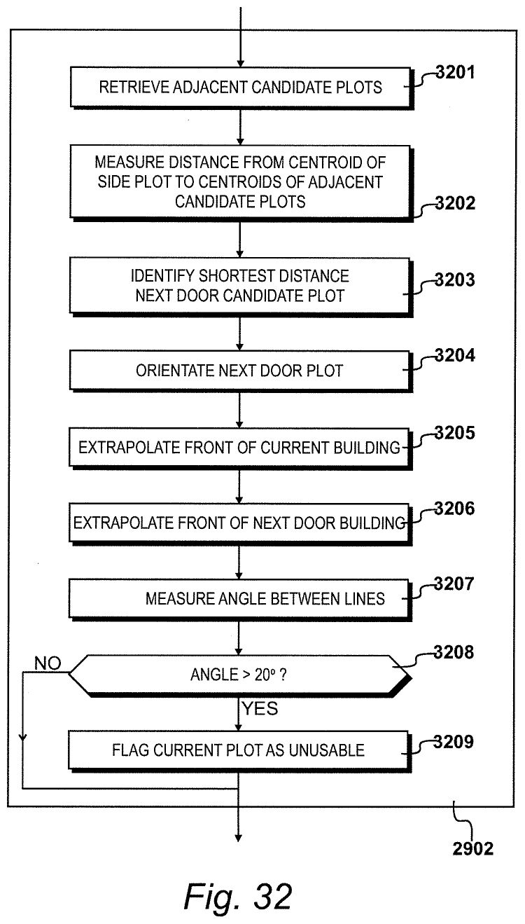

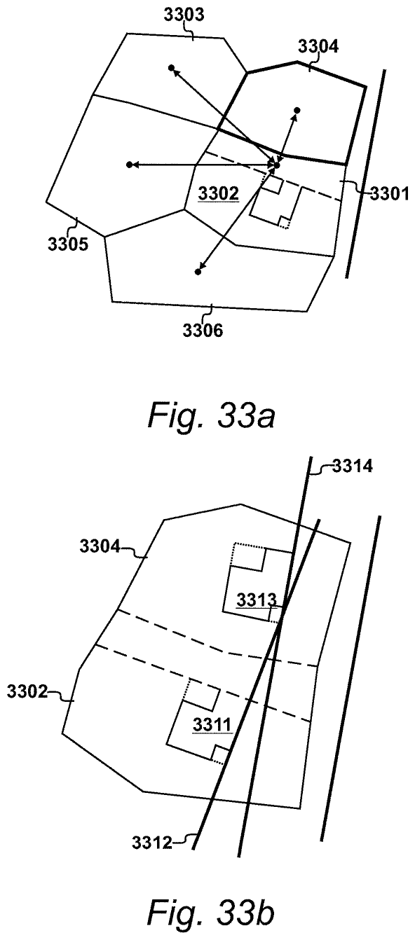

### FIGS. 32, 33a, 33b, 33c and 33d

FIG. 32 details step 2902, at which a side plot is rejected if it is on a bend or hammerhead, illustrated in FIGS. 33a, 33b, 33c and 33d.

To determine this, it is first necessary to identify the candidate plot that is adjacent to the side plot. Thus, at step 3201 all the candidate plots adjacent to the current candidate plot are retrieved from table 403. It does not matter whether they have been processed yet or not. At step 3202 the distances from the centroid of the side plot to the centroids of the adjacent candidate plots are measured, and at step 3203 the shortest distance is identified in order to identify the next-door plot. In FIG. 33a, side plot 3301 of candidate plot 3302 is being considered. The distances from the centroid of side plot 3301 to the centroids of adjacent candidate plots 3303, 3304, 3305 and 3306 are measured. Distance 3307 to the centroid of plot 3304 is the shortest, and therefore plot 3304 is adjacent to side plot 3301. This means it is the next-door plot to candidate plot 3302, on the side of side plot 3301.

To proceed, the process needs to identify the front of the buildings on both the current candidate plot and the next-door plot. The current candidate plot has already been orientated at step 603, and the orientation of the next-door plot is obtained at step 3204. If the next-door plot has already been processed, then this information will already be in potential plot data table 404. If it has not been processed, then processing of this plot can be started in order to orientate it.

At steps 3205 and 3206, a line is extrapolated from the front of the best-fit rectangle around each building, as can be seen in FIG. 33b. The front of building 3311 on plot 3302 is extrapolated to line 3312. The front of building 3313 on plot 3304 is extrapolated to line 3314. The angle between these lines indicates whether the two buildings are roughly lined up along a straight or lightly-curved road, or whether a curve in the road has caused the front of one building to be considerably turned away from the other.

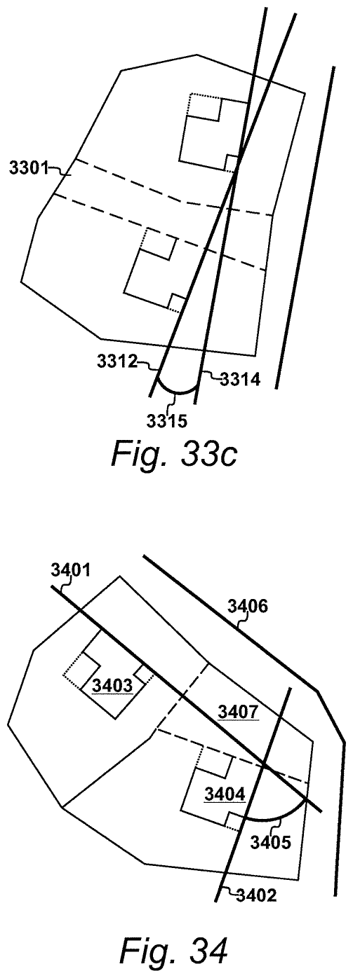

In FIG. 33c, the angle 3315 between lines 3312 and 3314 is small, showing that the buildings 3311 and 3313 are roughly lined up. Side plot 3301 is a usable plot. However, in the alternative example of FIG. 34, lines 3401 and 3402 have been extrapolated from the fronts of buildings 3403 and 3404 respectively. The angle 3405 between the lines is much larger, indicating that the fronts of the buildings are angled away from each other. This is caused by the bend in the road 3406, and it can be seen that side plot 3407 is fully adjacent to the road and must therefore be considered unusable. The same would apply to a candidate plot at the top of a hammerhead.

Thus, at step 3207 the angle between the lines is measured, and at step 3208 a question is asked as to whether this angle is greater than 20°. This number is a user-configurable option. If this question is answered in the affirmative then the side plot is tagged as unusable at step 3209. Unlike candidate plots on a corner, as considered during step 2901, the other side plot in the candidate plot may well be usable and is therefore processed as normal.

### FIGS. 35 and 36

Step 2104, at which access to a side plot is considered, is detailed in FIG. 35 and illustrated in FIG. 36. Usually, a side plot has access to the road link corresponding to the building address. However, where a house is built at an unusual angle to the road, or at the end of a driveway surrounded by other houses, this may not be the case. In addition, the method described herein may mis-identify a rear plot as a side plot, and in that case would not carry out the usual access checks associated with a rear plot. Thus, at this step, the method checks whether there is actually access to a side plot.

Thus, at step 3501 the shortest line is drawn from the centroid of the side plot to the road link identified at step 1001. At step 3502 a question is asked as to whether this line intersects with any other candidate plot. If this question is answered in the negative then at step 3503 the intersection of this line with the road link is stored as a potential access point.

Alternatively, if the question is answered in the affirmative, then no action is taken and no access point is stored. The side plot will then be flagged as not viable at step 2106 because no access has been identified.

In the example of FIG. 36, building 3602 stands on candidate plot 3601, and it is associated with roadlink 3603. Because of the sharp bend in road 3603, and because building 3602 is set well back from the road, the furthest potential plot from road 3603 is the small area 3604 down the side of the building. This causes the method to orientate the building side-on, thus mis-identifying rear plot 3605 as a side plot. However, the shortest line 3606 from the centroid of side plot to road link 3603 passes through the adjacent candidate plot 3607, and therefore no access is identified.

### FIG. 37

FIG. 37 details step 1405, at which further optional checks on the plot are carried out. At this stage, potential plots have been processed and are either fully processed, or flagged as unusable or non-viable. Unusable plots cannot be used and are therefore generally not subject to further checks. Non-viable plots are probably not usable on their own but may be combined with other plots to create a viable plot. Depending on the nature of the further checks, they may also be omitted from this step.

Thus, depending on the data generated during steps 1402 and 1404, step 3707 may be carried out or may be omitted. Although it is not specifically detailed herein, these further checks may also be carried out on assembled plots generated during step 314, for example following step 2306 (see FIG. 23).

The checks carried out at this stage provide further information on plots that may be of use to requesting users. At step 3701 a check is carried out to ascertain whether any building on the plot may require a fire suppression system. At step 3702 any other optional checks, not detailed herein, are carried out.

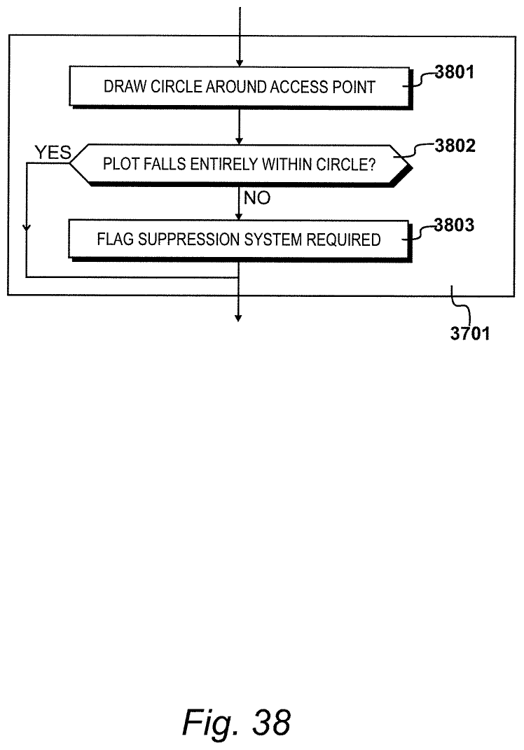

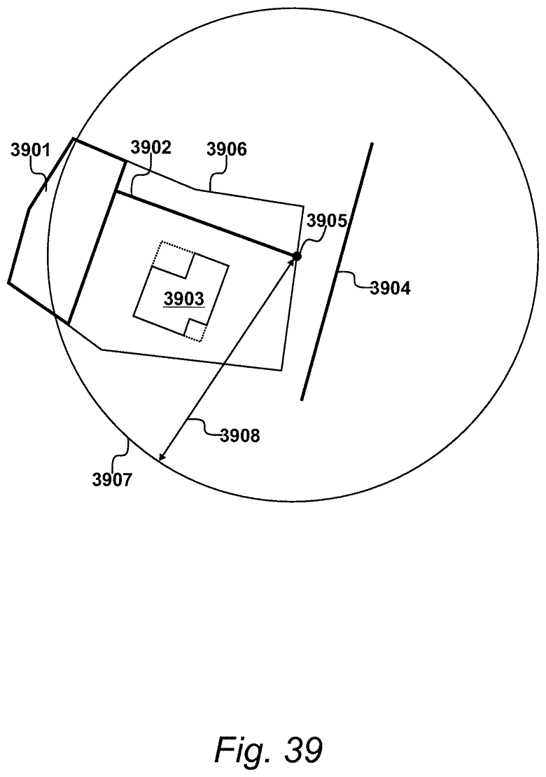

### FIGS. 38 and 39

Step 3701 at which a fire suppression system check is carried out is detailed in FIG. 38 and illustrated in FIG. 39. Many countries have building regulations requiring a fire suppression system if a building is too far from the road for a fire engine hose to reach. In the UK, every corner of a building must be less than 65 metres from the road; this varies around the world and therefore the distance used in the check is a user-configurable variable.

Thus at step 3801 a circle of radius 65 metres is drawn. In this embodiment it is drawn around the access point that has been identified during processing of the potential plot and stored in access data 446; in other embodiments or due to user-configurable conditions the circle may be centred on another point. As shown in FIG. 39, a rear potential plot 3901 has been identified, and it has potential access shown by line 3902, down the side of building 3903 to road link 3904. The point 3905 where access line 3902 intersects with land boundary 3906 is the centre of the drawn circle 3907. In this embodiment the radius 3908 is 65 metres.

At step 3802 a question is asked as to whether the potential plot falls entirely within the drawn circle. If this question is answered in the negative, then at step 3803 the potential plot is flagged as possibly requiring a fire suppression system (depending on which part of the plot is built on).

In FIG. 39, it can be seen that part of plot 3901 falls outside circle 3907, and thus this plot would be flagged for a fire suppression system.

1. A method of automatically processing geospatial data, comprising the steps of:
obtaining base geospatial data relating to plots of land and buildings;
using said base geospatial data, identifying first geospatial data describing a first real-world plot of land and second geospatial data describing a first real-world building standing on said plot of land, said building having an unknown real-world orientation;
using said second geospatial data, creating a first polygon that encompasses said building;
using said first geospatial data:
identifying a portion polygon that is not in said first polygon, said portion polygon defining a portion of said plot of land, and identifying its orientation with respect to real-world orientation of said first building; and
storing said portion polygon and data relating to said portion for display.

2. A method according to claim 1, wherein:
said first geospatial data comprises a second polygon, and said second geospatial data comprises a third polygon,
and determining where said first polygon is a best-fit rectangle for said third polygon.

3. A method according to claim 2, wherein said step of identifying a portion polygon comprises the steps of:
selecting a first edge of said first polygon and extrapolating it to generate a first line that intersects with said second polygon;
segmenting said portion polygon using said first line to create at least two areas; and
identifying one of said areas that does not contain said first polygon as said portion polygon.

4. A method according to claim 3, wherein said step of identifying a portion polygon further comprises the step of reducing the size of said portion polygon by:
generating a second line that is parallel to and at a first pre-determined distance from said first edge, and that intersects with said portion polygon;
segmenting said portion polygon using said second line to create at least two areas; and
discarding from said portion polygon the area closest to said first edge.

5. A method according to claim 1, wherein a first plurality of portion polygons are identified, and said step of identifying the orientation of a portion polygon with respect to the real-world orientation of the building comprises the steps of:
obtaining, from said base geospatial data, third geospatial data identifying a road associated with said building, said third geospatial data comprising a line;
for each of said first plurality of portion polygons, calculating a distance from said portion polygon to said line; and
using said distances to identify each of said portion polygons as defining a portion at the front, rear or side of the plot of land.

6. A method according to claim 5, further comprising the step of identifying the portion polygon as defining a portion on the left or right side of the plot, comprising the steps of:
identifying the portion polygon having the shortest distance to said line as the front polygon;
identifying one of said portion polygons as a first side polygon;
one of:
identifying another of said portion polygons as a second side polygon and calculating the angle from a point in said first side polygon to a point in said second side polygon, or
calculating the angle from a point in said first side polygon to a point on the edge of said first polygon that is adjacent to said first side polygon;
wherein said angle is measured around a point in said front polygon; and
using said angle, determining whether said side polygon defines a portion on the left or right side of the plot.

7. A method according to claim 5, further comprising the step of determining whether a portion polygon identified as defining a portion at the rear of said plot has access to the front of the plot, comprising the steps of:
identifying the shortest distance from said first polygon to said second polygon at one side of the plot of land; and
if said distance is larger than a first threshold, identifying that said rear portion polygon has access to the front of the plot.

8. A method according to claim 5, further comprising the step of determining whether a portion polygon identified as defining a portion at the rear of said plot has access to a road, comprising the steps of:
generating a fourth polygon that is a duplicate of said portion polygon, enlarged by a second pre-determined distance;
identifying, from said base geospatial data, fourth geospatial data identifying a road, said fourth geospatial data comprising a line that intersects with said fourth polygon.

9. A method according to claim 5, further comprising the step of determining whether a portion polygon identified as defining a portion at the side of the building is adjacent to a road corner, comprising the steps of:
generating a fifth polygon that is a duplicate of said portion polygon, enlarged by a third pre-determined distance;
identifying, from said base geospatial data, one or more geospatial data identifying one or more roads, said one or more geospatial data comprising one or more lines that intersect with said fifth polygon; and
if more than one road has been identified, determining whether any of said lines intersect with each other.

10. A method according to claim 5, further comprising the step of determining whether a portion polygon identified as defining a portion at the side of the building is adjacent to a bend in the road, comprising the steps of:
using said base geospatial data, identifying a set of geospatial data, each describing a real-world plot of land that is adjacent to said first real-world plot of land, wherein said set may be empty; and
if said set is not empty:
identifying the closest plot of land in said set to said portion polygon, and identifying a sixth polygon encompassing a polygon that describes a second real-world building standing on it;
orientating said sixth polygon with respect to the real-world orientation of said second building;
calculating an angle between a line extrapolated from the front of said third polygon and a line extrapolated from the front of said sixth polygon; and
if said angle exceeds a second threshold, determining that said portion polygon is adjacent to a bend in the road.

11. A method according to claim 5, further comprising the step of determining whether a portion polygon identified as defining a portion at the side of said plot has access to a road, comprising the steps of:
determining the shortest line between the centroid of said portion polygon and the line in said third geospatial data; and
identifying whether said shortest line intersects with geospatial data in said base data describing another real-world plot of land.

12. A method according to claim 5, further comprising the steps of determining whether a fire suppression system would be required for a hypothetical building built on the land defined by a portion polygon, by:
identifying access details for the portion polygon, and determining the point on said second polygon where access will be achieved;
drawing a circle of a predetermined radius centred on said point; and
determining whether the portion polygon falls entirely within said circle.

13. A method of creating an assembled polygon, comprising the steps of:
carrying out the method of claim 1 a plurality of times, thereby identifying a plurality of first and second geospatial data describing real-world plots of land and real-world buildings, and identifying at least one portion polygon for each, to generate a second plurality of portion polygons;
identifying a set of said second plurality of portion polygons that are substantially adjacent to each other and therefore define a continuous real-world area;
generating an assembled polygon from said set of portion polygons, and storing said assembled polygon and data relating to said continuous real-world area for display.

14. Apparatus for automatically processing geospatial data, comprising a processor, storage and memory, wherein said processor is configured to:
obtain base geospatial data relating to plots of land and buildings;
using said base geospatial data, identify first geospatial data describing a first real-world plot of land and second geospatial data describing a first real-world building standing on said plot of land, said building having an unknown real-world orientation;
using said second geospatial data, create a first polygon that encompasses said building;
using said first geospatial data:
identify a portion polygon that is not in said first polygon, said portion polygon defining a portion of said plot of land, and identifying its orientation with respect to the real-world orientation of said first building; and
store said portion polygon and data relating to said portion for display.

15. Apparatus according to claim 14, wherein said processor is configured to identify a portion polygon by:
selecting a first edge of said first polygon and extrapolating it to generate a first line that intersects with said second polygon;
segmenting said portion polygon using said first line to create at least two areas; and
identifying one of said areas that does not contain said first polygon as said portion polygon.

16. Apparatus according to claim 15, wherein said processor is configured to identify a portion polygon by carrying out the further step of reducing the size of said portion polygon by:
generating a second line that is parallel to and at a first pre-determined distance from said first edge, and that intersects with said portion polygon;
segmenting said portion polygon using said second line to create at least two areas; and
discarding from said portion polygon the area closest to said first edge.

17. Apparatus according to claim 14, wherein said processor is configured to identify a first plurality of portion polygons, and identify the orientation of a portion polygon with respect to the real-world orientation of the building by:
obtaining, from said base geospatial data, third geospatial data identifying a road associated with said building, said third geospatial data comprising a line;
for each of said first plurality of portion polygons, calculating a distance from said portion polygon to said line; and
using said distances to identify each of said portion polygons as defining a portion at the front, rear or side of the plot of land.

18. Apparatus according to claim 17, wherein said processor is configured to identify a portion polygon as defining a portion on the left or right side of the plot, by:
identifying the portion polygon having the shortest distance to said line as the front polygon;
identifying one of said portion polygons as a first side polygon;
one of:
identifying another of said portion polygons as a second side polygon and calculating the angle from a point in said first side polygon to a point in said second side polygon, or
calculating the angle from a point in said first side polygon to a point on the edge of said first polygon that is adjacent to said first side polygon;
wherein said angle is measured around a point in said front polygon; and
using said angle, determining whether said side polygon defines a portion on the left or right side of the plot.

19. Apparatus according to claim 14, wherein said processor is configured to create an assembled polygon by:
identifying a plurality of first and second geospatial data describing real-world plots of land and real-world buildings, and identifying at least one portion polygon for each, to generate a second plurality of portion polygons;
identifying a set of said second plurality of portion polygons that are substantially adjacent to each other and therefore define a continuous real-world area;
generating an assembled polygon from said set of portion polygons, and storing said assembled polygon and data relating to said continuous real-world area for display.

20. A non-transitory computer-readable medium comprising instructions which, when executed by a computer, cause the computer to:
obtain base geospatial data relating to plots of land and buildings;
using said base geospatial data, identify first geospatial data describing a first real-world plot of land and second geospatial data describing a first real-world building standing on said plot of land, said building having an unknown real-world orientation;
using said second geospatial data, create a first polygon that encompasses said building;
using said first geospatial data:
identify a portion polygon that is not in said first polygon, said portion polygon defining a portion of said plot of land, and identifying its orientation with respect to the real-world orientation of said first building; and
store said portion polygon and data relating to said portion for display.
